(19) United States
(12) Patent Application Publication
(10) Pub. No.: US 2005/0049930 A1
(43) Pub. Date: Mar. 3, 2005

(54) System and method for processing of serialized products

(76) Inventor: Raymund Marcos Sampark Padilla, Paranaque (PH)

Correspondence Address: RAYMUND MARCOS S. PADILLA, 442 COOPER ST. MOONWALK VILLAGE, PARANAQUE, 1700, PH

(21) Appl. No.: 10/651,962

(22) Filed: Sep. 2, 2003

(51) Int. Cl. G06F 17/60

(52) U.S. Cl. 705/26

(57) ABSTRACT

A system and method for an internet based collaborative business to business and business to consume ordering, selling, servicing, warranty processing, remarketing, billing, payment, auction, shipment and monitoring of serialized products anywhere and anytime among various manufacturers, dealers and customers. This invention covers an infrastructure that includes computer hardware, computer software, programs, databases, development tools, internet applications, enterprise resource planning systems, legacy systems, point systems, business applications, internet systems, browsers, enterprise application interfaces, protocols, connectors, networks, wireless and mobile technology to process the transactions related to the proposed system and method.

### CROSS REFERENCE TO RELATED APPLICATIONS

U.S. PATENT DOCUMENTS

| | | | |
|---|---|---|---|
| 3,938,621 | February, 1976 | Bobbitt, Jr. | 184/1.5 |
| 4,404,639 | September, 1983 | McGuire, et. al. | 701/35 |
| 4,501,005 | February, 1985 | Miller | 377/20 |
| 4,525,782 | June, 1985 | Wohlfarth, et. al. | 701/99 |
| 4,533,900 | August, 1985 | Muhlberger, et. al. | 340/457.4 |
| 4,739,482 | April, 1988 | Wrigge | 701/30 |
| 4,989,146 | January, 1991 | Imajo | 701/35 |
| 5,058,044 | October, 1991 | Stewart, et. al. | 702/184 |
| 5,072,380 | December, 1991 | Randelman, et. al. | 705/13 |
| 5,495,531 | March, 1995 | Smiedt | 705/59 |
| 5,499,181 | March, 1996 | Smith | 455/456.1 |
| 5,541,840 | July, 1998 | Gume, et. al. | 701/33 |
| 5,657,233 | August, 1997 | Cherrington, et. al. | 705/400 |
| 5,717,595 | February, 1998 | Cherrington, et. al. | 705/400 |
| 5,734,569 | March, 1998 | Rogers, et. al. | 701/33 |
| 5,758,300 | May, 1998 | Abe | 455/424 |
| 5,774,873 | June, 1998 | Berent, et. al. | 705/26 |
| 5,818,914 | October, 1998 | Fujisaki | 379/93.12 |
| 5,819,201 | October, 1998 | DeGraaf | 701/208 |
| 5,835,898 | November, 1998 | Fisher, et. al. | 705/37 |
| 5,890,138 | March, 1999 | Godin, et. al. | 705/26 |
| 5,902,985 | May, 1999 | Bos, et. al. | 235/384 |
| 5,905,975 | May, 1999 | Ausubel | 705/37 |
| 5,913,210 | June, 1999 | Call | 707/4 |
| 5,918,214 | June, 1999 | Perkowski | 705/27 |
| 5,970,472 | October, 1999 | Allsop, et. al. | 705/26 |
| 5,978,774 | November, 1999 | Rogers, et. al. | 705/24 |
| 5,999,867 | December, 1999 | Rogers, t.al. | 701/29 |
| 6,003,808 | December, 1999 | Nguyen, et. al. | 244/IR |
| 6,008,201 | December, 1999 | Berent t al. | 705/27 |
| 8,012,045 | January, 2000 | Barzilai, et. al. | 705/37 |
| 6,021,398 | February, 2000 | Ausubel | 705/37 |
| 6,032,088 | February, 2000 | Feldmann, et. al. | 701/33 |
| 6,044,383 | March, 2000 | Mori, et. al. | 705/37 |
| 6,055,516 | April, 2000 | Johnson, et. al. | 705/27 |
| 6,055,518 | April, 2000 | Franklin, et. al. | 705/27 |
| 6,067,486 | May, 2000 | Aragones, et. al. | 701/29 |
| 6,070,155 | May, 2000 | Cherrington, et. al. | 705/400 |
| 6,072,481 | June, 2000 | Matsushita, et. al. | 707/102 |
| 6,125,312 | September, 2000 | Nguyen, et. al. | 701/35 |
| 6,151,589 | November, 2000 | Aggarwal, et al. | 705/37 |
| 6,163,693 | December, 2000 | Rydbeck | 455/418 |
| 6,170,742 | January, 2001 | Yacoob | 235/375 |
| 6,181,994 | January, 2001 | Colson, et al. | 701/33 |
| 8,199,050 | March, 2001 | Alaia, et. al. | 705/37 |
| 8,208,853 | March, 2001 | LoVasco, et. al. | 455/414.1 |
| 6,216,114 | April, 2001 | Alaia, et. al. | 705/37 |
| 6,223,167 | April, 2001 | Alaia, et. al. | 705/37 |
| 6,240,286 | May, 2001 | Rydbeck | 4551414.1 |
| 8,243,691 | June, 2001 | Fisher, et. al. | 705/37 |
| 8,253,129 | June, 2001 | Jenkins, et. al. | 701/29 |
| 6,263,322 | July, 2001 | Kirkevold, et. al. | 705/400 |
| 8,266,651 | July, 2001 | Woolston | 705/27 |
| 6,266.852 | July, 2001 | Godin, et. al. | 705/37 |
| 6,282,489 | August, 2001 | Rogers, et. al. | 701/29 |
| 6,282,518 | August, 2001 | Farrell, et. al. | 705/26 |
| 6,285,932 | September, 2001 | de Bellefeuille, et. al. | 701/33 |
| 6,308,120 | October, 2001 | Good | 701/29 |
| 6,321,262 | November, 2001 | Springer | 709/223 |
| 6,321,348 | November, 2001 | Kobata | 714/37 |
| 6,330,499 | December, 2001 | Chou, et. al. | 701/33 |
| 6,370,454 | April, 2002 | Moore | 701/29 |
| 6,374,122 | April, 2002 | Leung | 455/551 |
| 6,389,337 | May, 2002 | Kolls | 701/29 |
| 6,405,111 | June, 2002 | Rogers, et. al. | 701/33 |
| 6,408.232 | June, 2002 | Cannon, et. al. | 701/29 |
| 6,408,283 | June, 2002 | Alaia, et. al. | 705/37 |
| 6,430,486 | August, 2002 | Diaz, et. al. | 701/33 |
| 6,434,455 | August, 2002 | Snow, et. al | 701/33 |
| 6,477,452 | November, 2002 | Good | 701/29 |
| 6,480,105 | November, 2002 | Edwards | 340/457 |
| 8,484,150 | November, 2002 | Blinn, et. al. | 705/26 |
| 6,490,637 | December, 2002 | Shih | 710/8 |
| 6,493,615 | December, 2002 | Johnston | 701/29 |
| 8,499,018 | December, 2002 | Alaia, et. al. | 705/37 |
| 6,505,108 | January, 2003 | Lawrence, et. al. | 701/35 |
| 6,505,172 | January, 2003 | Johnson, et. al. | 705/27 |
| 6,512,988 | January, 2003 | de Bellefeuille, et. al. | 701/33 |
| 6,519,470 | February, 2003 | Rydbeck | 455/466 |
| 6,539,296 | March, 2003 | Diaz, et. al. | 701/33 |
| 6,549,904 | April, 2003 | Ortega, et. al. | 707/10 |
| 6,550,021 | April, 2003 | Dalphy et al. | 714/11 |
| 6,553,290 | April, 2003 | Pillar | 701/33 |
| 6,553,292 | April, 2003 | Kokes, et. al. | 701/33 |
| 6,554,183 | April, 2003 | Sticha, et. al. | 235/379 |
| 6,556,904 | April, 2003 | Larson, et. al. | 701/33 |
| 6,560,516 | May, 2003 | Baird, et. al. | 701/23 |
| 6,564,128 | May, 2003 | Baird, et. al. | 701/33 |
| 6,584,192 | May, 2003 | Kinney, Jr. et al. | 705/37 |
| 6,567,730 | May, 2003 | Tanaka | 701/33 |
| 6,578,001 | June, 2003 | Schramek | 705/1 |
| 6,587,768 | July, 2003 | Chene et al. | 701/33 |
| 6,591,098 | July, 2003 | Shieh et al. | 455/419 |

### STATEMENT REGARDING FEDERALLY SPONSORED RESEARCH OR DEVELOPMENT

Not applicable

REFERENCE TO SEQUENCE LISTING. A TABLE. OR A COMPUTER PROGRAM LISTING COMPAC-DISK APPENDIX

Not applicable

### BACKGROUND OF THE INVENTION

1. Field of the Invention

This invention relates in general to business to business and business to consumer based business applications and auction systems which covers ordering, selling, servicing, warranty processing, remarketing, billing, payment, auction, shipment and monitoring of serialized products. Examples of serialized products include vehicles, aircraft, bouts, consumer electronics, appliances, cellular phones, equipment, machines, sub components and any products that have serial numbers or unique identifying numbers used for warranty registration and service processing.

2. Description of Prior Art

In the current business environment, manufacturers are having difficulties in managing their sales and inventory forecasting accuracy to address the real time customer demands because they don't have real time information about the actual sales made by their dealers. We will refer to the manufacturers as the original equipment manufacturer (OEM) of serialized products. We will refer to the dealers as the reseller, retailers and/or service agents of serialized products whether these dealers are owned by the OEMs of not. Poor decisions are made because most of the information the manufacturer get from dealers are either inaccurate or delayed considering that most dealers are not using a packaged business application or an in-house developed and computer programmed business application which we will both refer to as current business applications.

Dealers, who are mostly owned by individual businessmen or companies not owned by these manufacturers, are faced with intense pressure to install a current business application in their company. Unfortunately, most of these dealers do not have the budget to install and maintain a current business application. This is one of the primary reasons on why dealers are just using manual or computer desktop based office systems.

If ever these dealers are capable of acquiring the current business applications, the next problem they face is confined to flexibility of these current business applications to share data while maintaining limited access to other servicing dealers as provided in the scenario below.

In the market today, customers wanted their serialized products to be serviced in any certified dealer aside from their selling dealer. Selling dealer refers to a selling entity where the serialized product was first sold. The major reason is convenience because customers right now are very demanding and they wanted their serialized products to be serviced anywhere and anytime as much as possible with less effort, time and money wasted. Such scenarios include 1) an Asian based CEO on a very important business trip to Europe when his serialized product (i.e. laptop with important business files needed for the board presentation or a mobile phone with important contracts) malfunctions 2) an imported vehicles that need to undergo a free under war checkup or simply 3) a household appliance like a refrigerator that malfunctions and spoils the perishable ingredients of our favorite meal. It is evident in these scenarios that there is urgency to service and repair these products while proximity between the customer and selling dealer is an issue. Of course, if the serialized product is still under warranty, customers would avail this. Unfortunately, there is an ongoing practice that most servicing dealers would not accommodate the warranty processing if the serialized product was not originally sold by them. It ever they would accommodate the under warranty product, they would request for the warranty card or any proof that is sufficient to consider the product as under warranty.

When customers go to the nearest servicing dealer, servicing dealers are now faced with the problem of checking the products service history because the paper based service and warranty booklet was lost, damaged, not updated or simply not brought by the customer. Of course, cut will not carry all warranty booklets for all their owned serialized products wherever and whenever they go and sacrifice their convenience. In order to address this, most of these servicing dealers will validate this information from selling or other servicing dealers thru phone or fax both as the primary and crude way of communicating. Afterwards, the contacted selling or other servicing dealer will try to retrieve this information manually from their filing cabinets containing hundreds or thousands of customer and service files or thru their current business applications with service processing and history monitoring capability. In most cases, they will not do this because of time, effort and money being wasted. Again, the problem does not end here.

The customer is faced with another major problem due to non-cooperation among dealers. Most dealers are owned by different entities and these dealers will restrict the access of customer information to other dealers due to competitive reasons. The only way that they will allow access to these records if it is restricted to getting the serialized product's unique identifying number tied to the owner customer. Customer information such as customer name, address, etc. are not disclosed to the servicing dealer. Again, the problem does not end here.

If dealers reach an agreement to cooperate and initiate a computer based project to allow restricted information to be shared among themselves, further issues will be encountered such as: 1) system infrastructure restrictions because dealers maintain different kinds of business applications, 2) logistics issues in managing a global project to standardize the business applications and processes of all dealers connecting to the manufacturer's current business application, 3) budget restrictions because there will always be a dealer segment that finds the acquisition of business application so expensive and 4) project ownership where they cannot decide on who takes the lead on the project and where would the proposed system be hosted. This kind of approach requires huge amount of time, effort and money.

Prior art attempts to solve this by putting an online product registration for warranty processing. But it is not clear on how it is handled and whether it is handled by the manufacturer, individual dealers or a third party. If ever prior art is successful in implementing an online product registration using business applications with warranty processing capability, they are faced with a major and very important issue which lies on the technological incapability of current business applications whether internet ready or not.

Current business applications of manufacturers and dealers follow a forward linear structure model for information capture as provided in FIG. 34 which is a major shortcoming of prior art and recent attempts to automate the registration process. This model reflects the characteristic that whenever a serialized product is sold or consigned by the manufacturer to the dealer, the serialized product information is assigned to the dealer's records by the sales system of the manufacturer's current business application. Furthermore, dealer systems or business applications will classify these serialized products as stock items. Once the serialized product has been sold and assigned to the customer, a customer record is created and stored in the dealer's business application. Therefore, this forward linear structure model allows assignment of sold serialized product to customer on a per dealer basis but will not automatically assign the customer to other dealers who are potential service dealers. This forward linear structure model allows one manufacturer to multiple dealer assignment of multiple serialized products and one dealer to multiple customer assignments of multiple serialized products BUT not one customer to multiple dealer assignment. In effect, customer records with corresponding serialized products are only created per dealer and these records are not made available automatically via internet to other dealers as illustrated in FIG. 35. If ever current business applications or prior art will allow the restricted information on customer and serialized product records available to all dealers by replicating this information to all dealers, this will require a huge amount of database storage with unnecessary records in their respective systems on top of the difficulty of creating computerized system with interfaces to standardize the capture of data among various dealers maintaining various business applications as illustrated in FIG. 36. After realizing the inefficiency brought by this approach, servicing dealers without any customer and product information will just create new records every time that a new customer brings the serialized product for servicing. Dealers and customers experience delays and inaccurate information being entered into the system due to this.

Therefore, there is no current business application in the market that allows sharing of customer any serialized product information an a per need basis, by automatic transfer and assignment of required registration date thru a press of a button, for service processing among various manufacturers, dealers and customers over the internet on a global scale.

Dealers use the phone, fax or email as means to provide service and preventive maintenance reminders to customers thus incurring extra time, money and effort. Most of the time it is the customer's discretion to bring the serialized product to dealer for preventive maintenance based on the customer's convenience. In most cases, customers will bring their serialized product for preventive maintenance when they are free and only to find out that they missed the preventive maintenance schedules. There is opportunity loss for the dealer while the customer is exposed to unplanned product breakdowns. Prior art focus specifically on vehicles. Prior art attempts to solve this by installing vehicle diagnostic systems which transmits vehicle performance or other metrics needed to calculate the preventive maintenance schedules. Method of transmission includes usage of wireless or mobile technology installed on areas where vehicle traffic exists. Also, prior art makes use of GPS technology to provide the owner with details of nearest service center. This requires huge amount of investment on structure to make it successful. Also, prior art focus on diagnostics system and method and not on how customer, product, dealer, manufacturer and service data are being handled and interrelated.

There is no current business applications in the market that defines on how customer, product, dealer, manufacturer and service data are being managed and used to allow the retrieval of serialized product's service history by the dealer, automatic sending of service reminders or notifications based on the service history to the customer and retrieval of these service reminders or notifications by the customer over the internet on a global scale irregardless on whether the serialized products are dependent or not on diagnostic systems. Furthermore, there is no existing art that updates and collectively extract this service information for future usage in product valuation calculation needed in the auction.

Potential customers who wanted to buy a new serialized product are faced with a dilemma of visiting all dealers in their vicinity so that they can collect information vital for deciding on what product to buy. They also scan through the dealer's website as a better alternative. Still, this consumes a lot of time and effort for the customer because they need to visit the physical and/or internet sites of all dealers selling the target product that the potential customer wanted based on preference. To make it convenient for the potential customer to select based on preference, selling entities use current internet based business applications and they act as intermediary or a virtual dealer/agent to consolidate all products for easy selection of potential customer. In effect, there is a channel reconfiguration to introduce the intermediary dealer who consolidates all serialized products irregardless of brand or manufacturer. Internet based intermediaries are created by interested individuals or corporations every time that they see a business need for potential customers who wanted to buy a product in a one stop shop over the internet. These internet based intermediaries and individual dealers use current business applications that allow selling of products over the internet and creation of customer records for sales processing, billing, payment and shipment. Because of the current business application limitation brought by the forward linear structure model, customer records are created per dealer during the sales transaction. Therefore, customer records are not automatically made available to other dealers for service and maintenance related processing in the future. In effect the servicing dealer replicate by encoding the customer and product record every time that a new customer visits the servicing dealer.

There is no current business application in the market that allows customers to select, buy and pay for me serialized products they bought irregardless of brand or manufacturer and automatically assign their bought product to their customer record for service and maintenance record creation that will be used for future service and maintenance processing of other servicing dealers.

Once the customer decides to sell their used serialized product, they will either post it in print or internet based classified ads or auction systems. These customers include individual owners or remarketing firms/dealers. Customers want a system where they can place all of their serialized products they intend to auction to a larger market anytime and anywhere while maintaining a very competitive offer at par with the market and the appraised value. If there is a way that a system can compute for its appraised value based on service history, then customers who maintain their serialized products in good condition can sell the at a very competitive price which differentiates their offering to other products with the same specifications but poorly maintained. Current business applications allow selling of this second hand serialized products in a commoditized manner thru various auction methods wherein these systems only post the second hand serialized products with corresponding pricing on the internet. There are no customer and service history details that are attached to these products to be used for evaluation by second buyers. We define second buyers as the individual or corporate entities who are interested to buy second hand or used serialized products.

There is no current business application in the market that allows auction participants to buy and sell serialized products which are valuated based on calculated and/or derived market and appraised value where the seller has an option to indicate the asking price and the buyer to select based on preference, valuation, price, service and customer histories.

Overall, there is no current business application in the market that allows a collaborative business to business and business to consumer ordering, selling, servicing, warranty processing, remarketing, billing, shipment payment and monitoring of serialized products anywhere and anytime among various manufacturers, dealers and customers because characteristics of prior art involves specific industry segment, specific processes and specific business participant. Therefore, prior art is restricted on to a certain extent and does not cover the total solution proposed by this invention.

Also, prior art does not discuss on how data are being automatically transmitted over the internet and stored in business applications. Prior art focus specifically on diagnostics and does not focus on data interconnection among customers, dealers, manufacturers, products and service. Prior art follows the forward linear store model.

### BRIEF SUMMARY OF THE INVENTION

This invention relates to a system and method for a collaborative business to business and business to consumer ordering, selling, servicing, warranty processing, remarketing, billing, shipment, payment and monitoring of serialized products anywhere and anytime among various manufacturers, dealers and customers.

The system and method for the total proposed solution comprise of: 1) master data upload, 2) user and company registration, 3) customer inquiry and registration, 4) sales and shipment processing, 5) reclassification from dealer stock into customer owned serialized product, 6) service and warranty processing, and 7) auction.

This invention covers an infrastructure that includes computer hardware, computer software, programs, databases, development tools, internet applications, enterprise resource planning systems, legacy systems, point systems, business applications, internet systems, browsers, enterprise application interfaces, protocols, connectors, networks, wireless and mobile technology to process the transactions related to the proposed system and method.

This invention is deployed on a global scale involving interconnection between various business applications and represents all of these in an internet based portal where manufacturers, dealers and customers access.

This invention provides a solution to handle the forward linear structure model limitation by allowing the replication of customer and serialized product data to the servicing dealer with proper authorization from customer. This invention eliminates the automatic replication of all customer and serialized product data to all dealers. Also, manual entry of data will be greatly reduced or eliminated.

This invention provides a central repository of data that is being created, linked, reclassified, updated and accessed by customers, dealers and manufacturers needed to efficiently and effectively manage inventory, sales and service related activities whenever and wherever over the internet.

This invention covers the total process of handling all serialized products from the time that the product is bought, sold, serviced and retired. All transactions related to these processes are automatically updated in the invention's system to be used for repair and auction services and historical analysis.

### BRIEF DESCRIPTION OF THE SEVERAL VIEWS OF THE DRAWING

FIG. 1 is a diagram showing the manufacturer, dealer, first buy and second buy customers connecting to the invention.

FIG. 2 is a diagram shoving that the invention caters to multiple manufacturers, dealers, first buy and second buy customers.

FIG. 3 is a diagram showing that the manufacturer master data, dealer master data and product master data are being uploaded to and stored in the invention's database system.

FIG. 4 is a master record showing the manufacturer master data fields for upload in the invention's database.

FIG. 5 is a master record showing the dealer master data fields for upload in the invention's database.

FIG. 6 is a master record showing the product master data fields for upload in the invention's database. This also mentions that each product code has a unique identification number that is being uploaded into the invention's database.

FIG. 7 is a diagram showing that each product code can maintain multiple unique identification numbers (UINs).

FIG. 8 is a diagram showing that each product code can maintain a set of multiple unique identification numbers.

FIG. 9 is a diagram showing an example of a product code with a set of multiple unique identification numbers. The example is a vehicle code with a set of descriptions mentioning that it is a sedan of model x and with an automatic transmission. This vehicle code maintains a set of unique identification numbers such as frame number, engine number and etc.

FIG. 10 is a diagram showing an example of a product code which is a vehicle code wherein each vehicle code maintains multiple vehicles with unique identifying numbers. This mentions that a product can have the same product codes for same product descriptions but with different set of unique identification numbers.

FIG. 11 is a diagram showing another example of a product code with a set of multiple unique identification numbers. The example is a PDA code with a set of descriptions mentioning that it is an O2 brand of portable device that is a pocket pc and a phone of model y. This PDA code maintains a set of unique identification numbers such as SN, IMEI Number and other unique identifiers.

FIG. 12 is a diagram showing another example of a product code with a unique identification number. The example is a household appliance code with a set of descriptions mentioning that it is a model z refrigerator with a 6 cubic feet dimension. This household appliance code maintains only one UIN.

FIG. 13 is a diagram showing dealers, with or without current business application, transmitting an electronic purchase order via the invention. This triggers an electronic sales order from the manufacturer's sales system's current business application and sends it via the invention. All information from the sales order is stored in the invention's database system.

FIG. 14 is a listing of all sales order information being stored in the invention's database system.

FIG. 15 is similar to FIG. 13 except that it also includes the inventory data stored in the invention's database system. This inventory data is passed on by the dealer's current business application after filtering the inventory required for the invention's internet based selling engine.

FIG. 16 is similar to FIG. 13 except that it defines that the invention can provide a purchasing system for dealers without a current business application thru its hosted business applications.

FIG. 17 is a diagram showing the data being extracted from the sales order for storage in the invention's database.

FIG. 18 is a logical diagram of the invention's internet portal that segments the manufacturer, dealer and customers into sub portals.

FIG. 19 is a logical diagram of the invention's internet portal showing the major processes per sub portal.

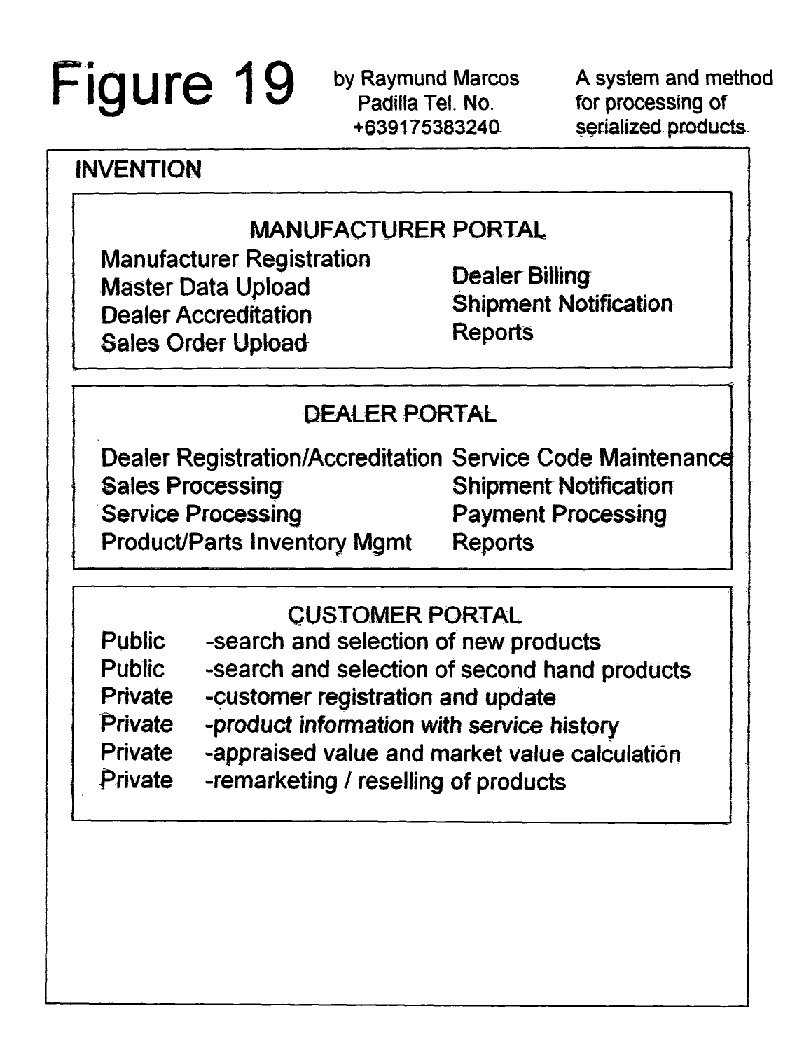

FIG. 20 is a master record showing the customer master data fields for upload from the dealer current business application in the invention's database. These customer master records can also be created and updated by the customers via the invention's customer sub portals.

FIG. 21 is a listing of the general product classification that is required by th invention for the manufacturer to identify their product classification.

FIG. 22 provides an example of a general product classification with corresponding UIN assignments. In this example, the frame number and chassis number are both specific to the vehicle as the general product classification.

FIG. 23 provides another example of a general product classification. In this example, the serial number is specific to the household appliance.

FIG. 24 is a listing of search criteria for brand new products that will be used by potential customers in finding their preferred products to buy.

FIG. 25 is a diagram showing that the ownership of product code with the UIN is changed automatically by the invention from the dealer code into customer code. This process happens after dealer confirms that the product has been sold to the customer.

FIG. 26 is a diagram showing the data entry fields in the dealer sub portal that allows the dealer to enter the invention system using a password. Afterwards, the dealer can process the service requirements of the customer by pressing the button to go into the service processing portion. But before the invention's system goes into the service screen, it will ask for the customer code, product code or UIN and customer password.

FIG. 27 is a diagram showing the service document header and details that are made available in dealer's portal of the invention. The confirm service button will trigger the customer code, product code with corresponding UIN assignment to the servicing dealer.

FIG. 28 is a diagram showing that the customer code, product code and UIN data are assigned to the servicing dealer every time that the servicing dealer confirms the service button found on FIG. 27. If there is no service rendered for other dealers, the system will not maintain any customer code and UIN data in their records.

FIG. 29 is a diagram showing the data available in the auction processing portion of a customer portal. The customer header and product details are both provided. The user selects products for auction by indicating a check mark on the boxes and press the confirm button to process the selected items for auction.

FIG. 30 is a diagram with auction items confirmed by the customer in FIG. 28. This allows the selling customer to enter a figure in the asking price portion. A button confirms the asking price for all products to be auctioned.

FIG. 31 is a listing of search criteria for second hand products that will be used by potential customers in finding their preferred second hand products to buy in the public portal of the invention's internet site.

FIG. 32 is the result of the search criteria for second hand products. This is a selection portion for the second hand buyers to flag the product that is being bought. A button press confirms the interest for the product to be bought.

FIG. 33 is a diagram showing that the product ownership is changed from the selling or first buy customer to the second buy customer code. Product code and corresponding UIN data are assigned to second buy customer code every time that the sale is confirmed by selling or first buy customer.

FIG. 34 is a diagram that represents the forward linear structure model that is followed by current business applications. Every time that a manufacturer creates and confirms a sales order to the dealer using their current business application the product code with corresponding UINs are assigned to the buying dealer. Likewise, every time a dealer creates and confirms a sales order to the buying customer using their current business application, the product code with corresponding UINs are assigned to the customer.

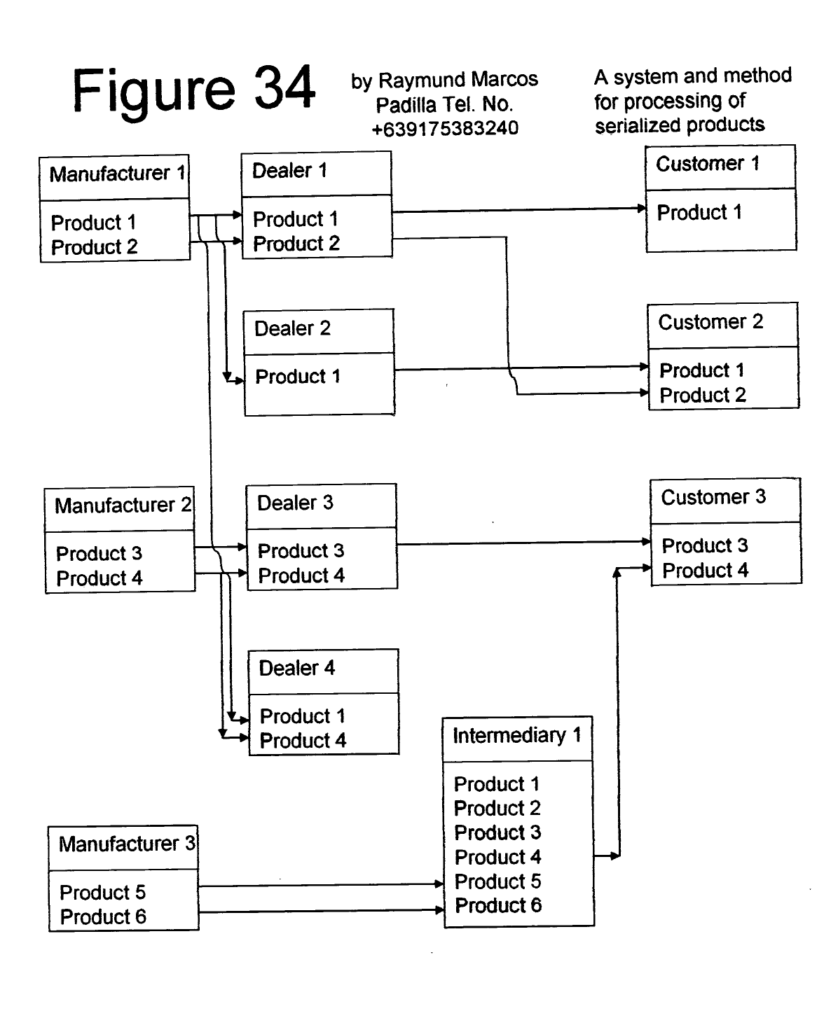

FIG. 35 is similar to FIG. 34 except that it states the limitation of a forward linear structure model where customer data is not possible for replication to other dealers. These ‘other dealers’ are referred to as dealers who are not the original selling dealer but potential servicing dealers.

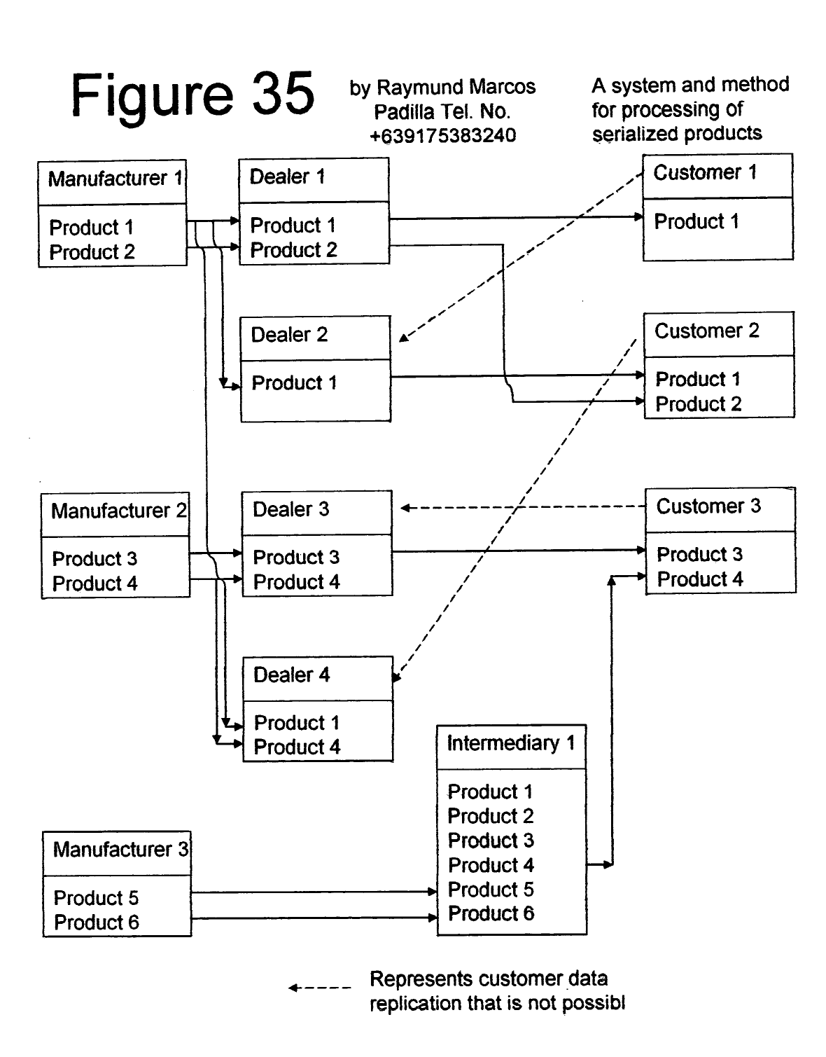

FIG. 36 is similar to FIG. 34 except that it states that each entity in current business ecosystems maintains different kinds of business applications or systems.

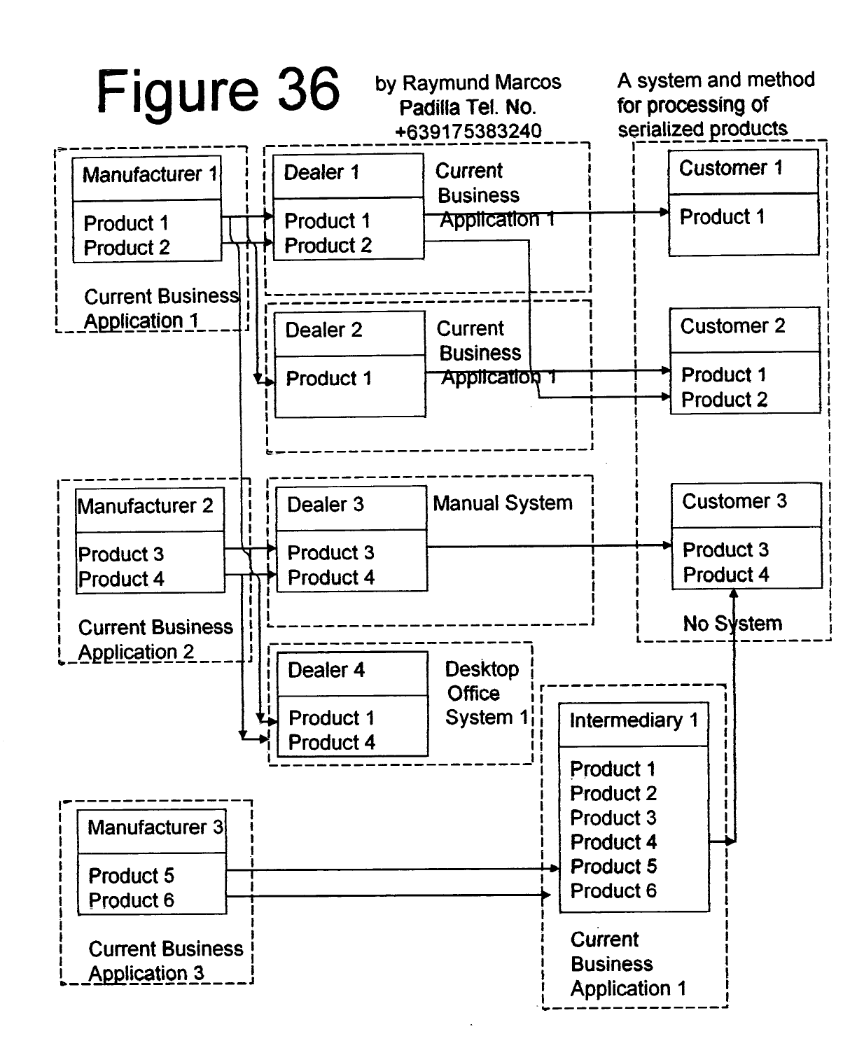

Diagrams represented in these figures are logical diagrams to represent the invention's logical process and are not to be interpreted as computer screen designs.

### DETAILED DESCRIPTION OF THE INVENTION

This invention covers a system and method for an internet based collate business to business and business to consumer ordering, selling, servicing, warranty processing, remarketing, billing, payment, auction, shipment and monitoring of serialized products anywhere and anytime among various manufacturers, dealers and customers.

This invention covers the first process where th manufacturer uploads all necessary data into the invention and ends when the second buy customer completes the buying process for the second hand serialized materials.

The system and method for the total proposed solution comprise of: 1) master data upload, 2) user and company registration, 3) customer inquiry and registration, 4) sales and shipment processing, 5) reclassification from dealer stock into customer owned serialized product, 6) service and warranty processing, and 7) auction.

This invention covers an infrastructure that includes computer hardware, computer software, programs, databases, development tools, internet applications, enterprise resource planning systems, legacy systems, point systems, business applications, internet systems, browsers, enterprise application interfaces, protocols, connectors, networks, wireless and mobile technology to process the transactions related to the proposed system and method.

This infrastructure will be deployed on a global scale involving interconnection between various business applications and represents all of these in an internet based portal where manufacturers, dealers and customers access.

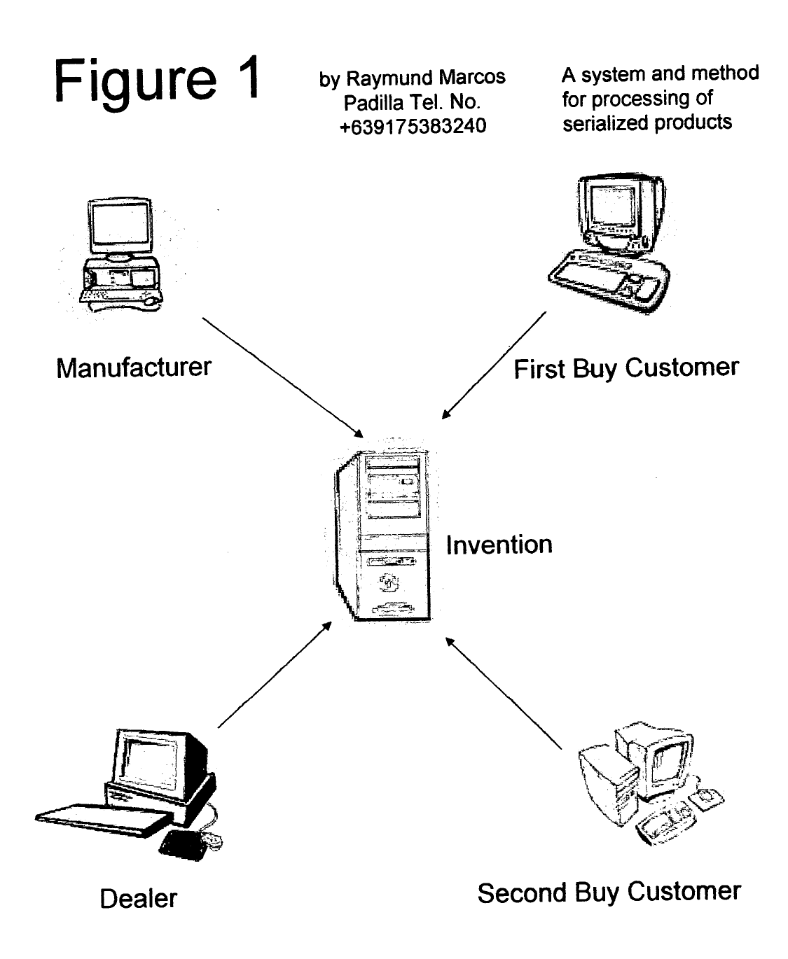

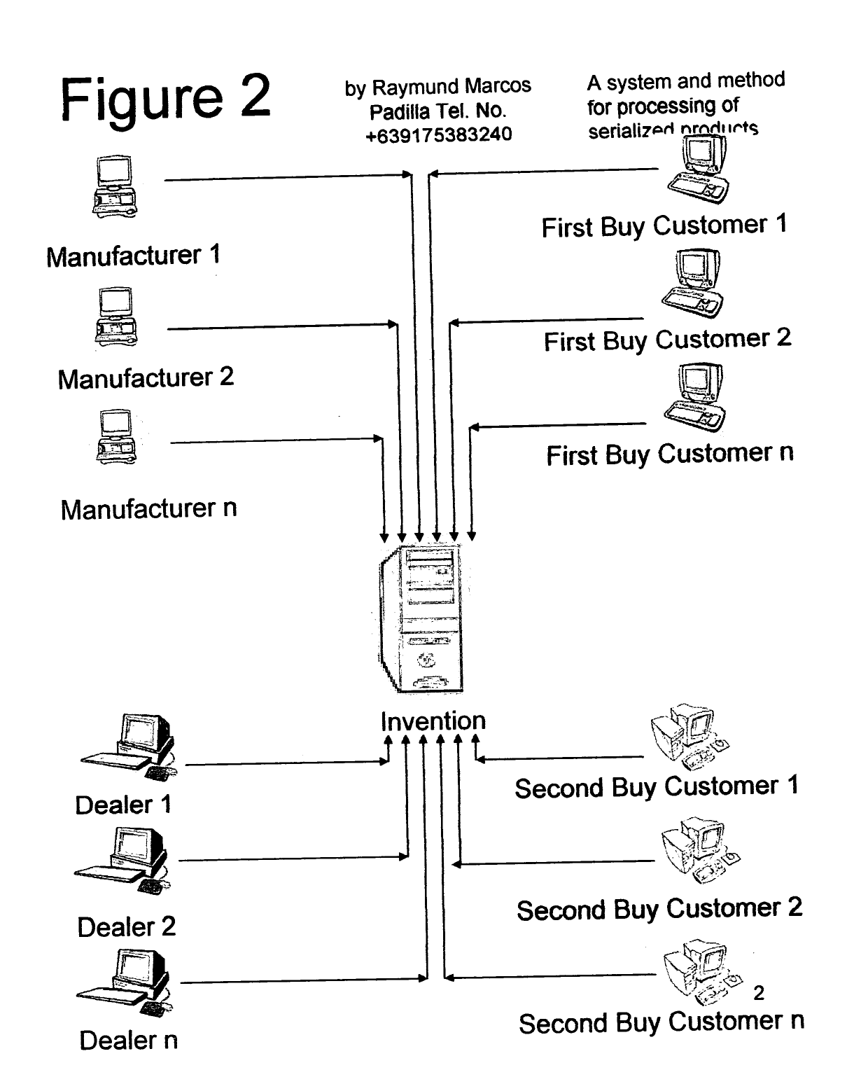

FIG. 1 provides an understanding of the manufacturer, dealer, first buy and second buy customers connecting to the invention. The manufacturer is defined as the manufacturer or producer of serialized products. Dealer is defined as the trading partner of the manufacturer who sells, distribute, service and repair the serialized products of end consumers. First buy customer is defined as the end customer who buys the brand new serialized product. Second buy customer is defined as the buyer of second hand or used serialized products. FIG. 2 provides an understanding that the invention will cater to all interested manufacturers, dealers, first buy and second buy customers for serialized and serviceable products on a global scale.

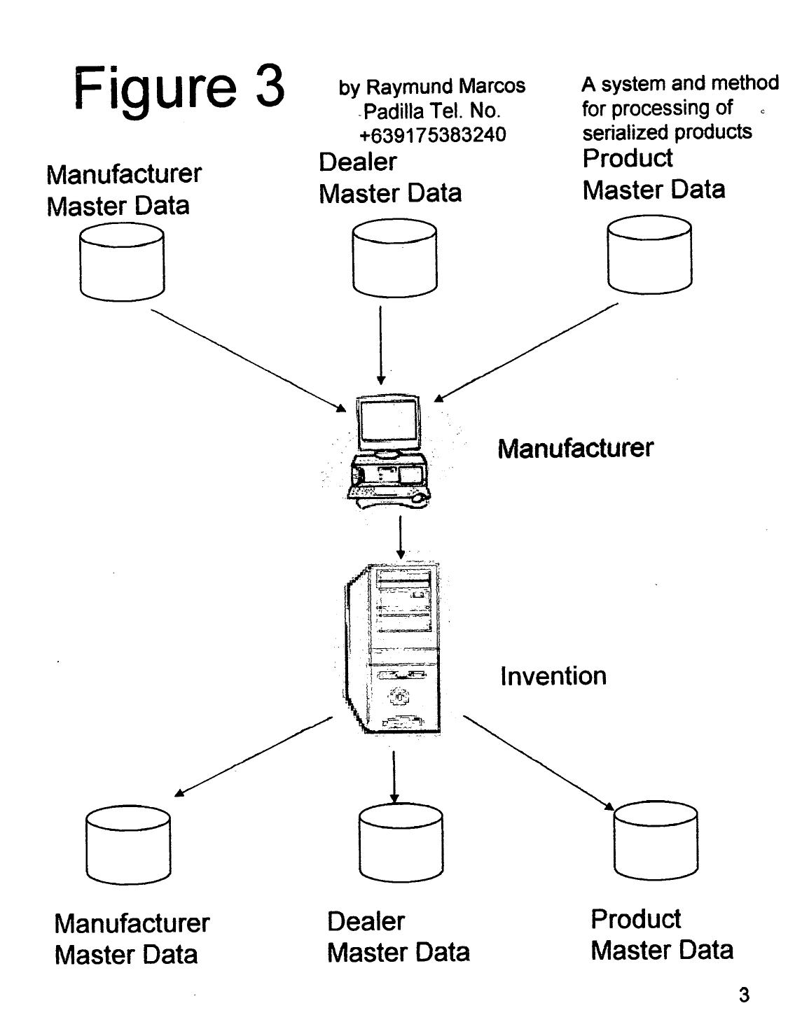

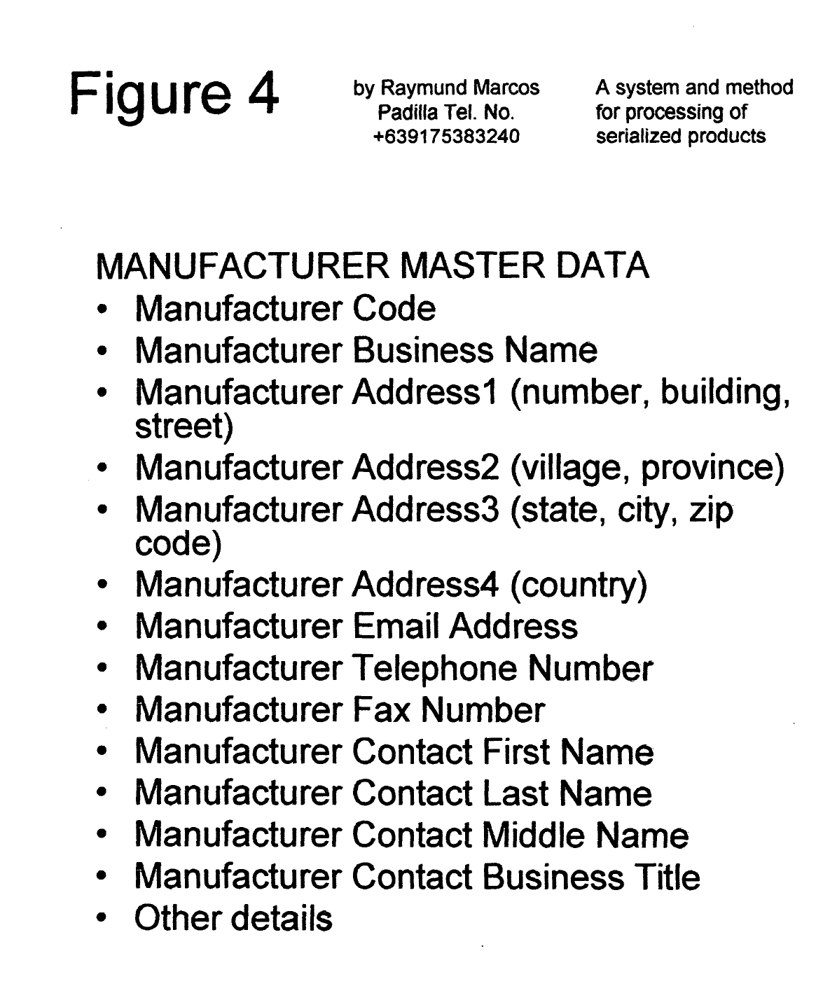

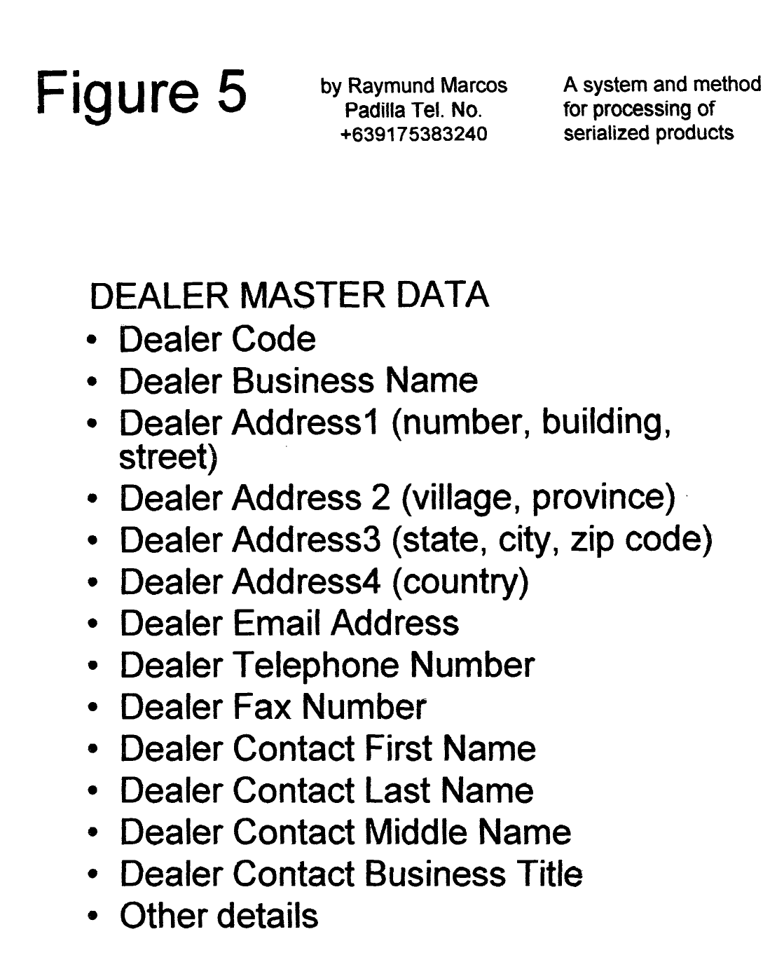

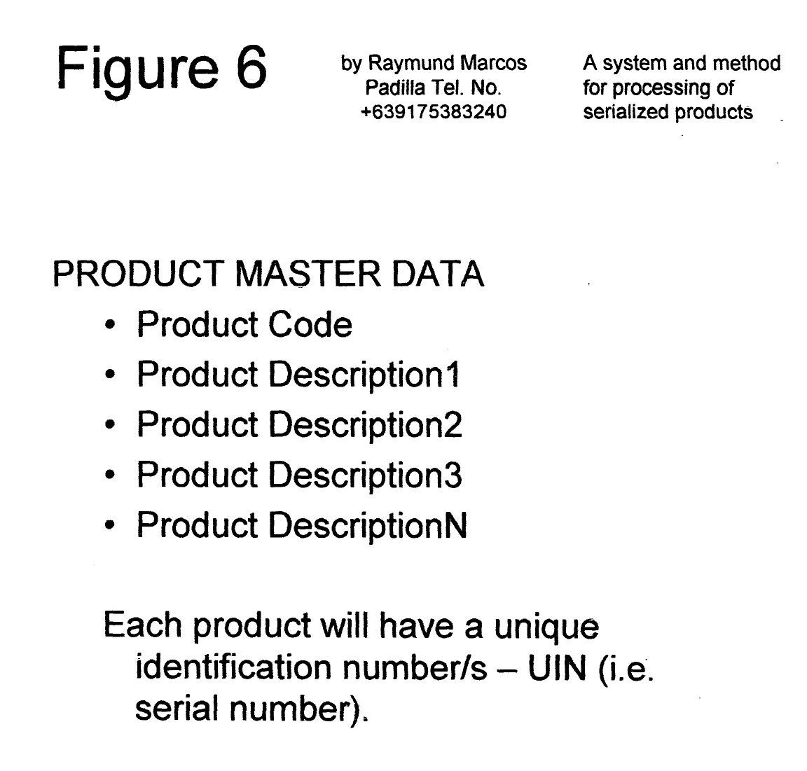

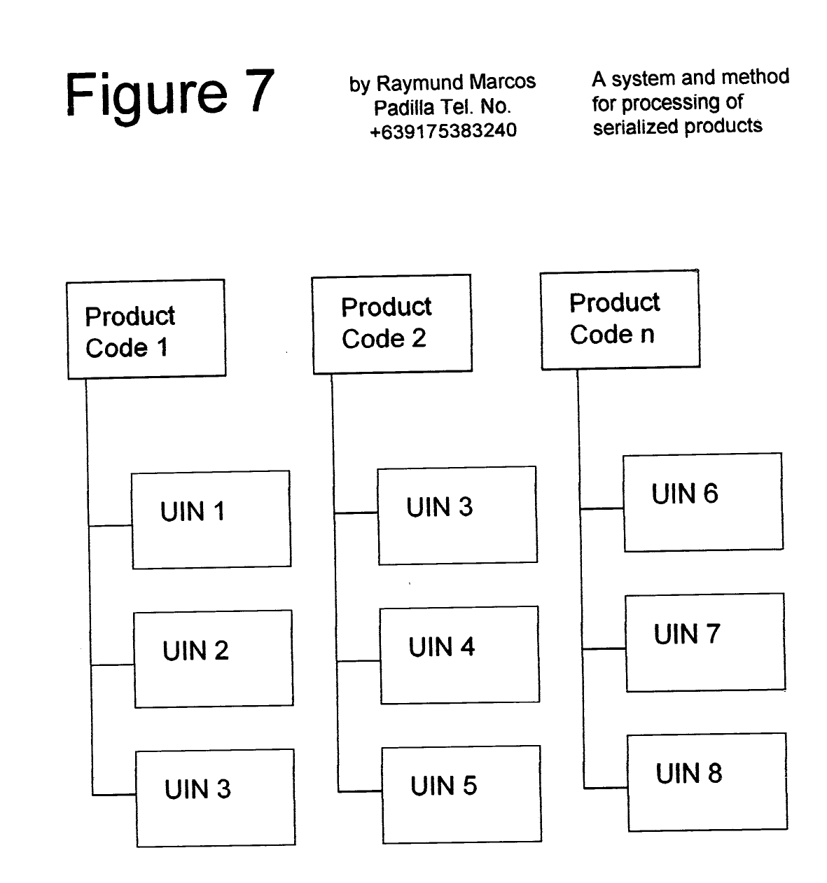

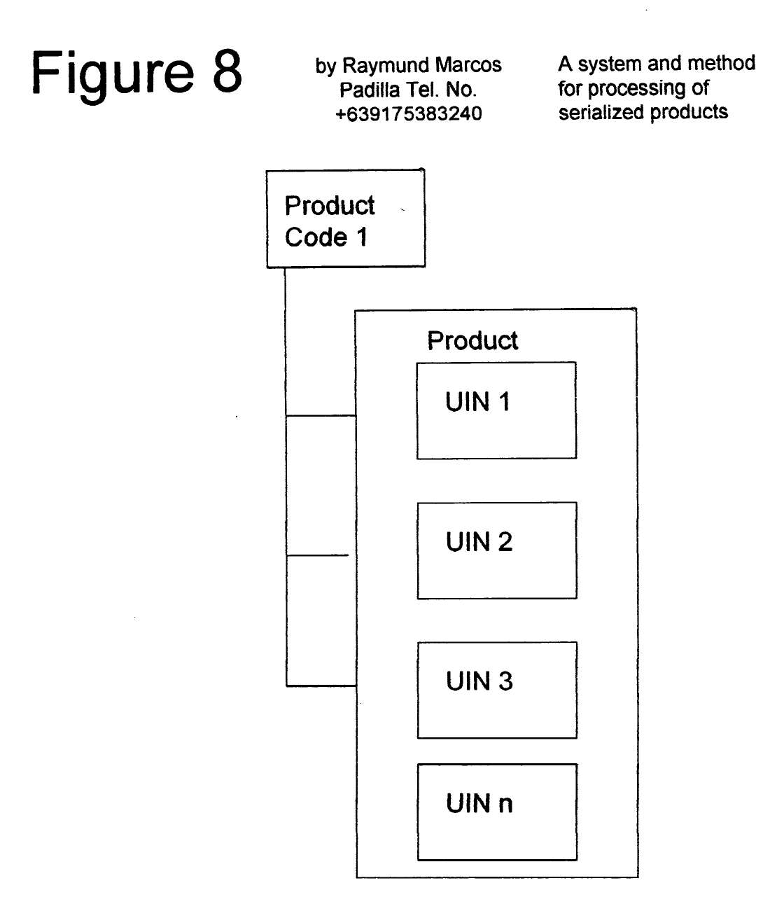

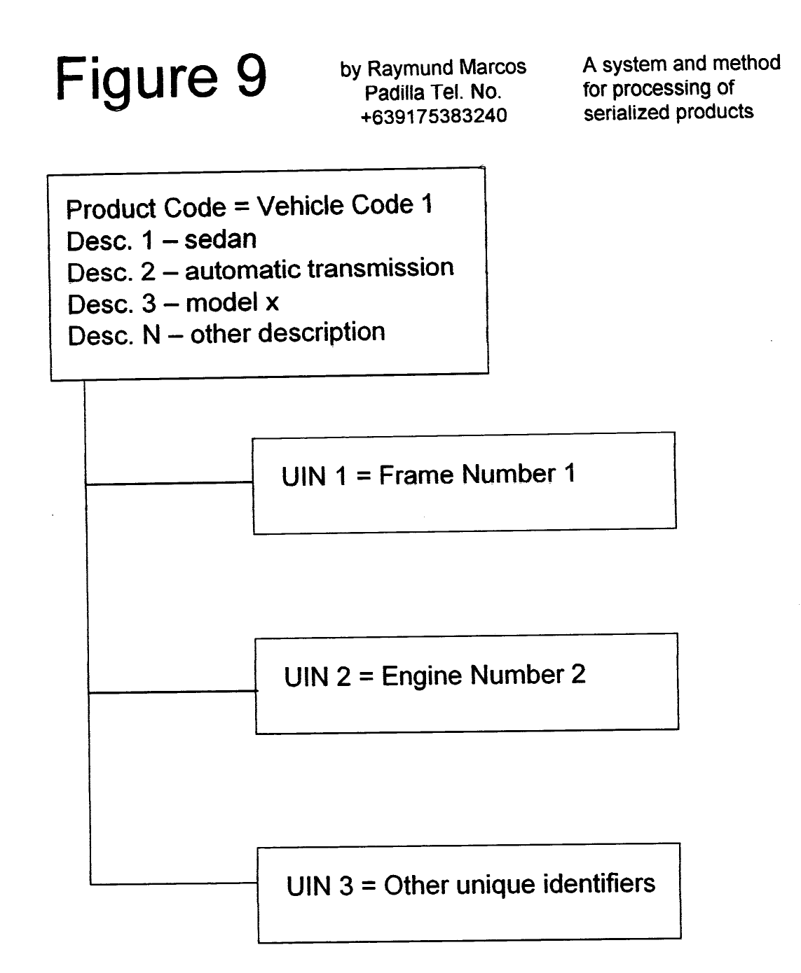

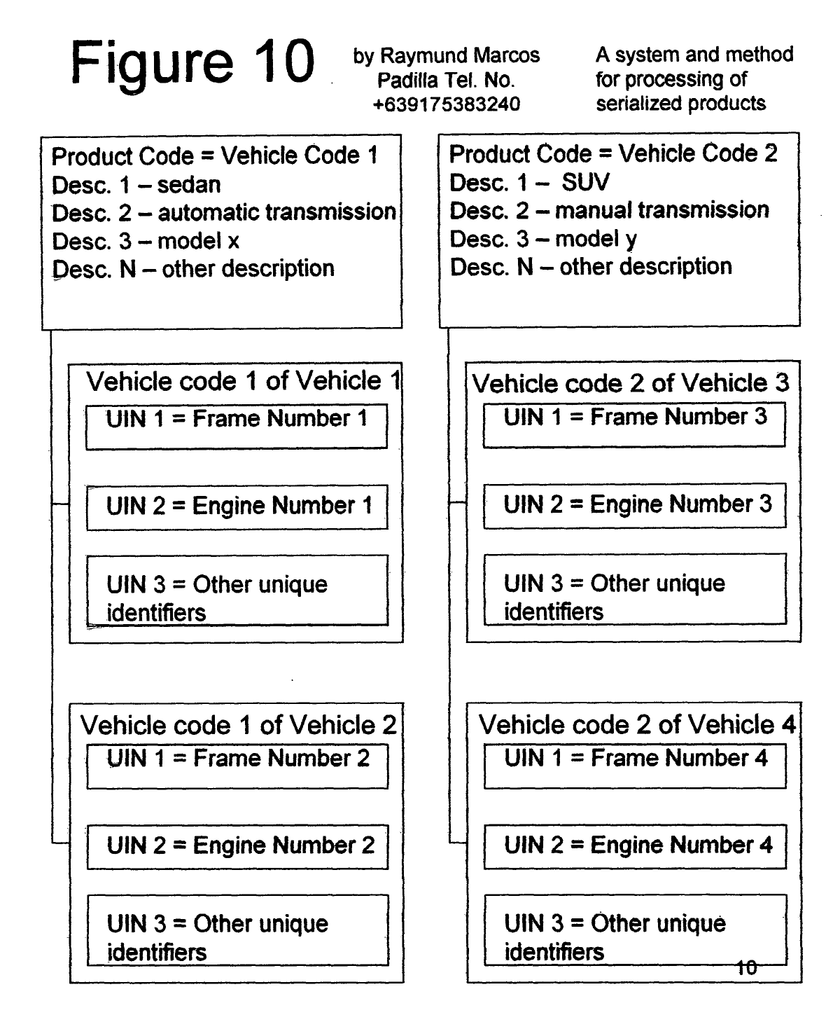

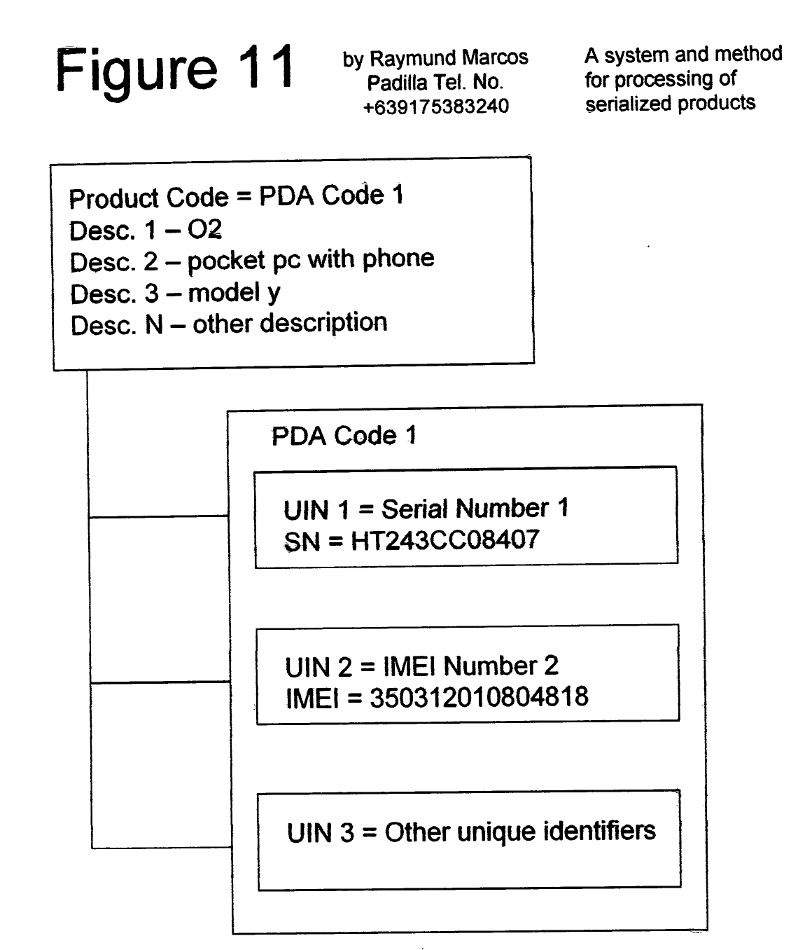

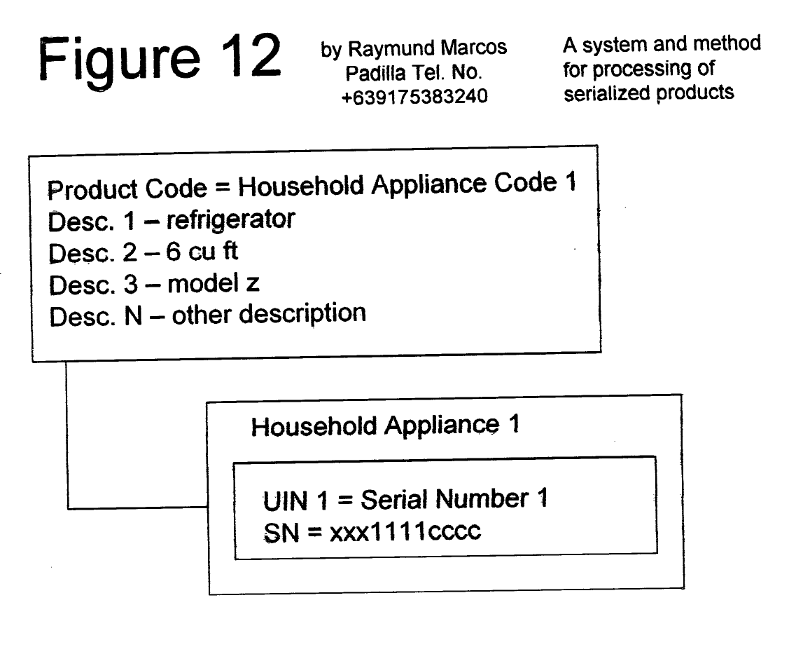

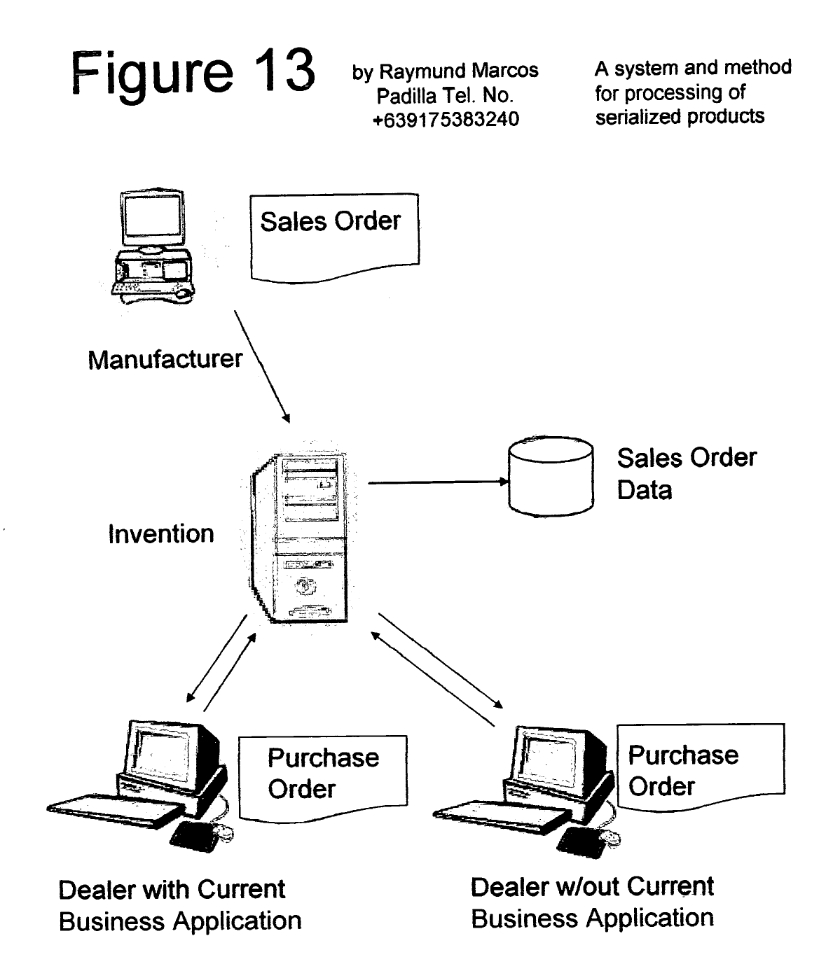

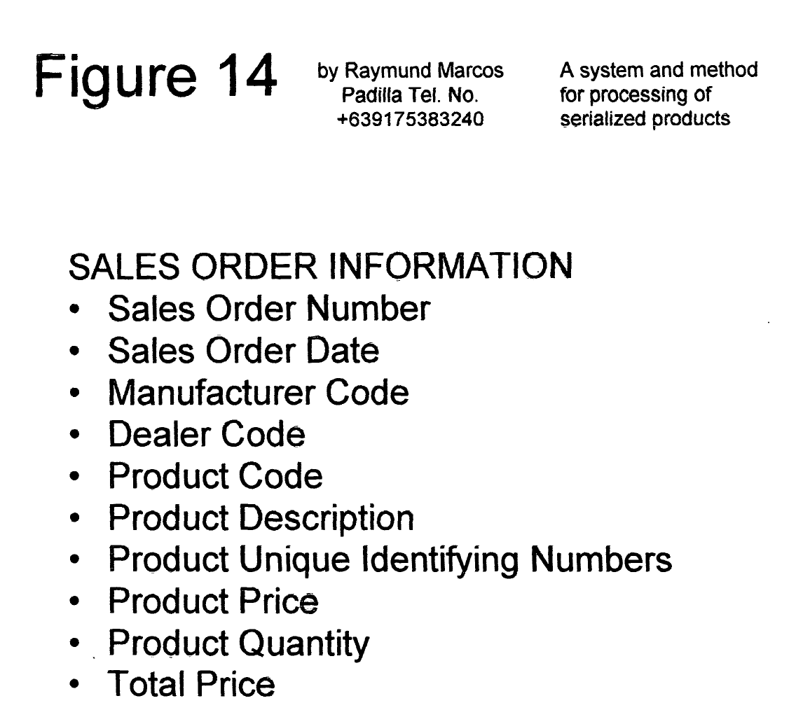

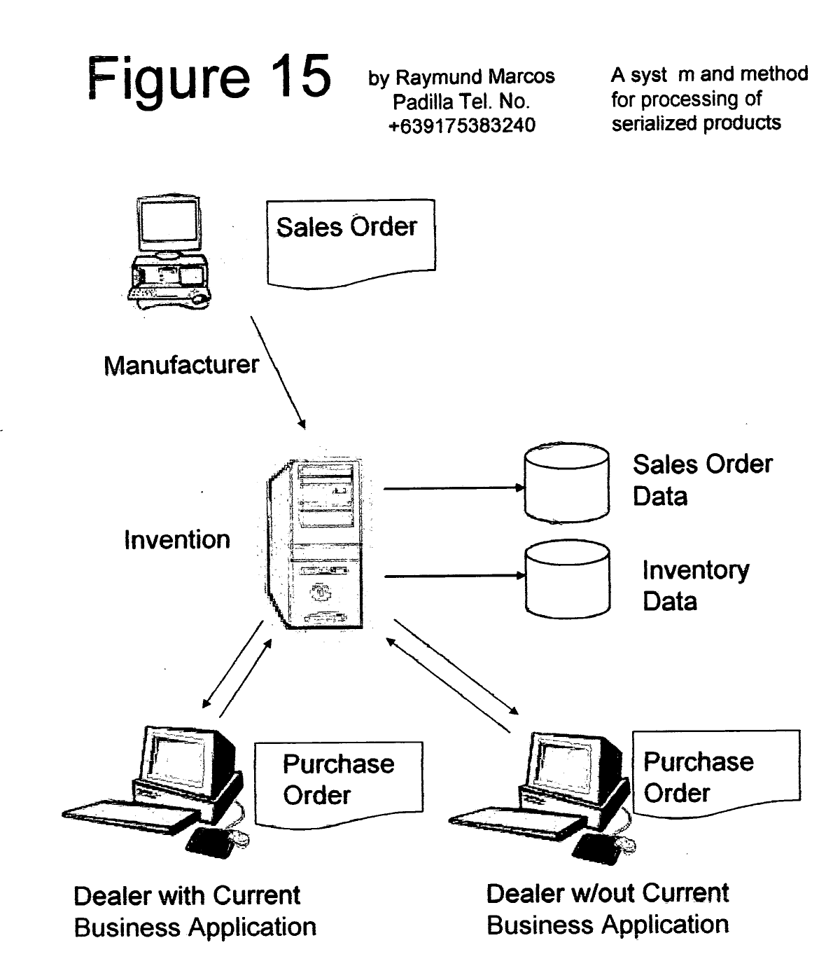

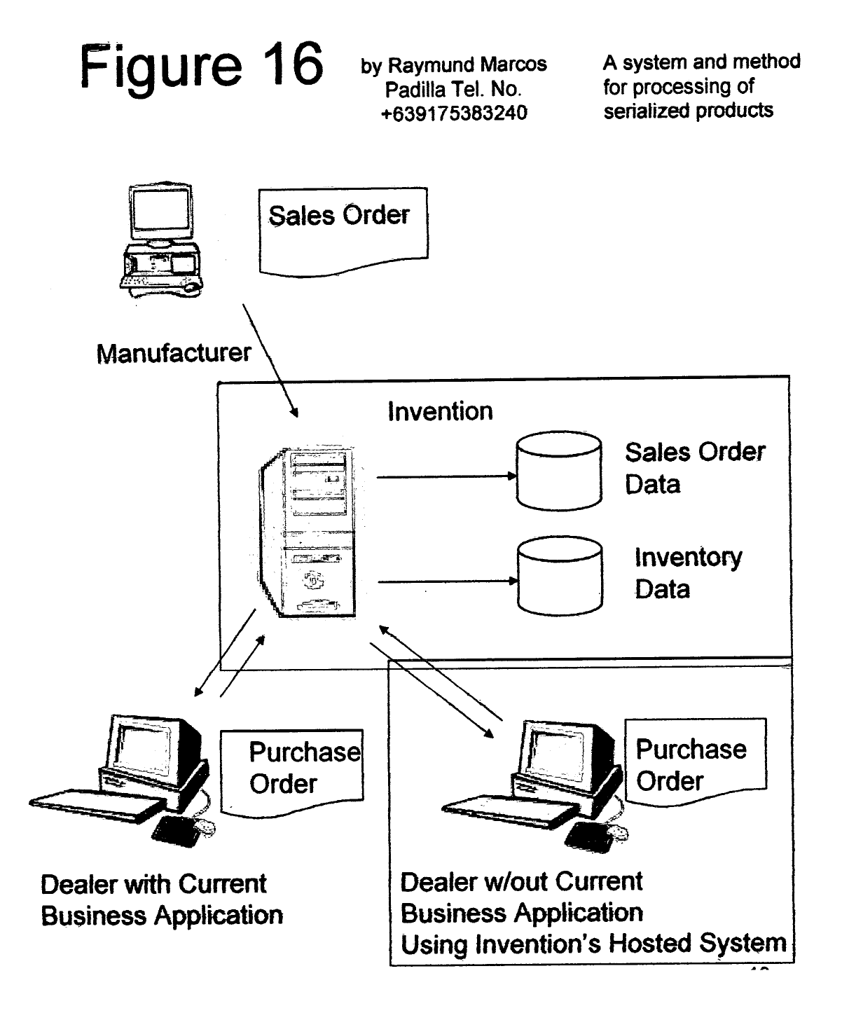

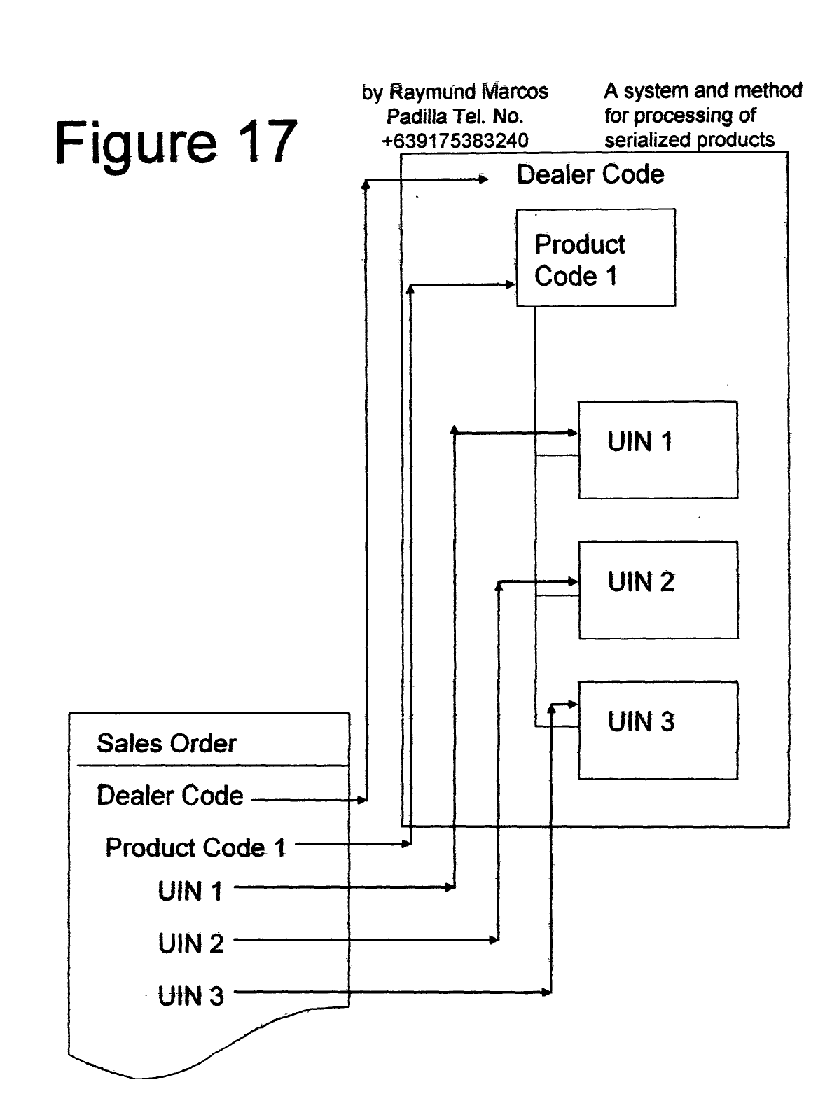

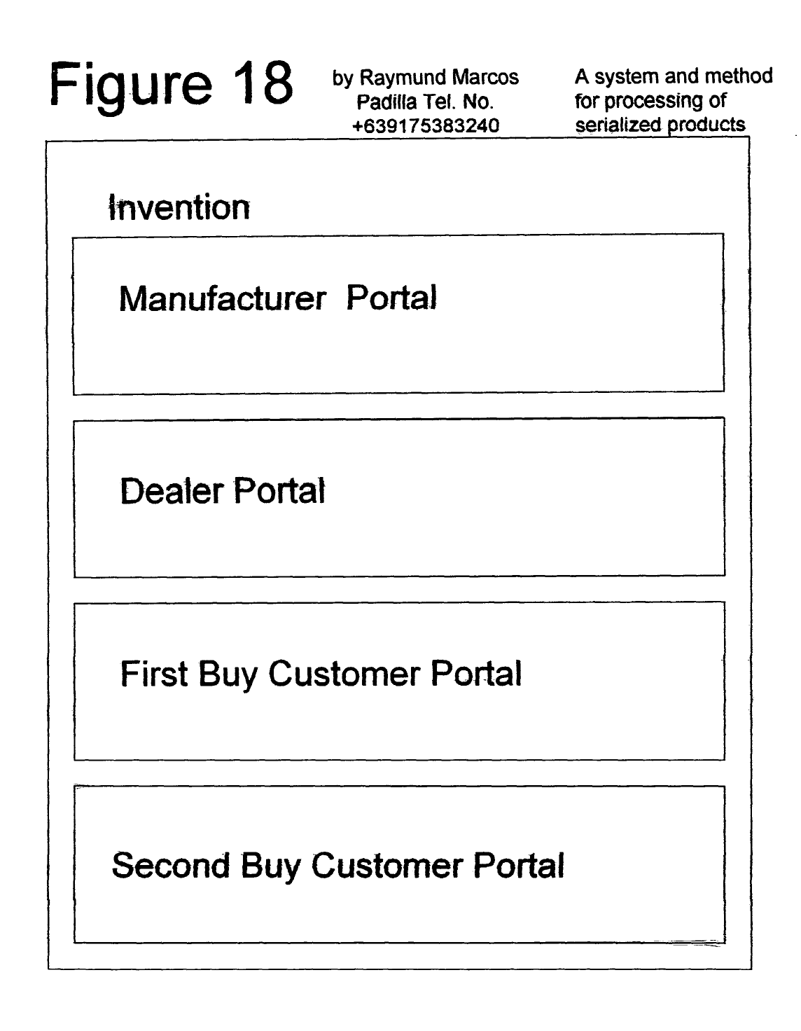

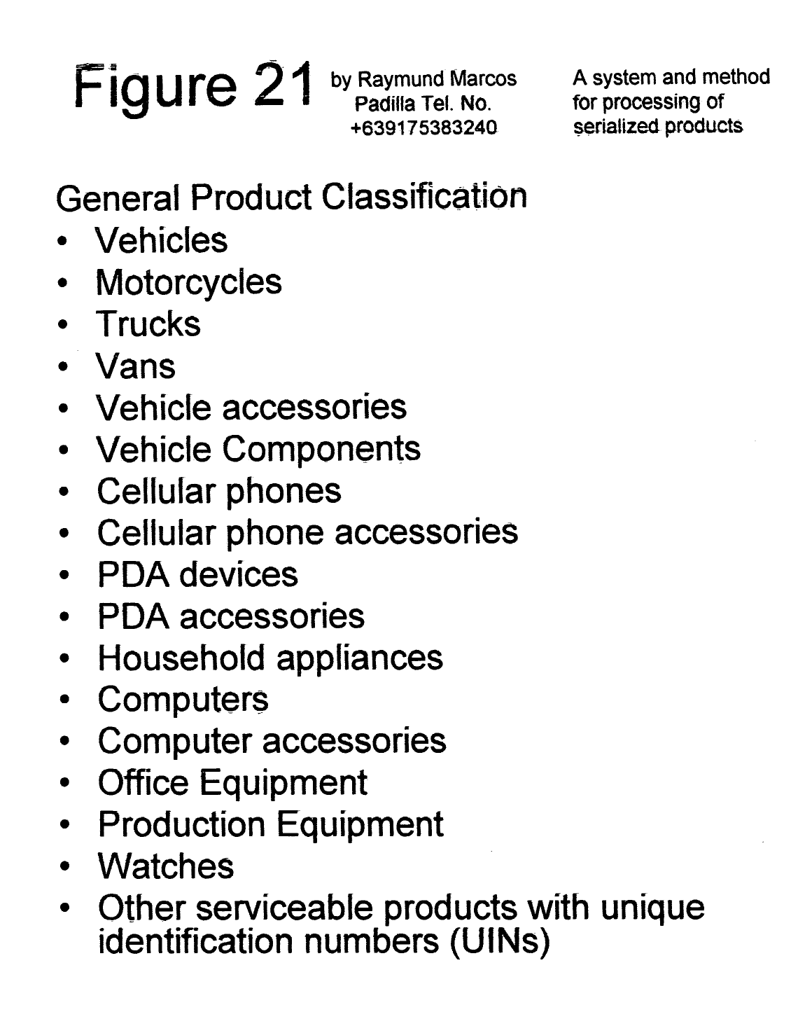

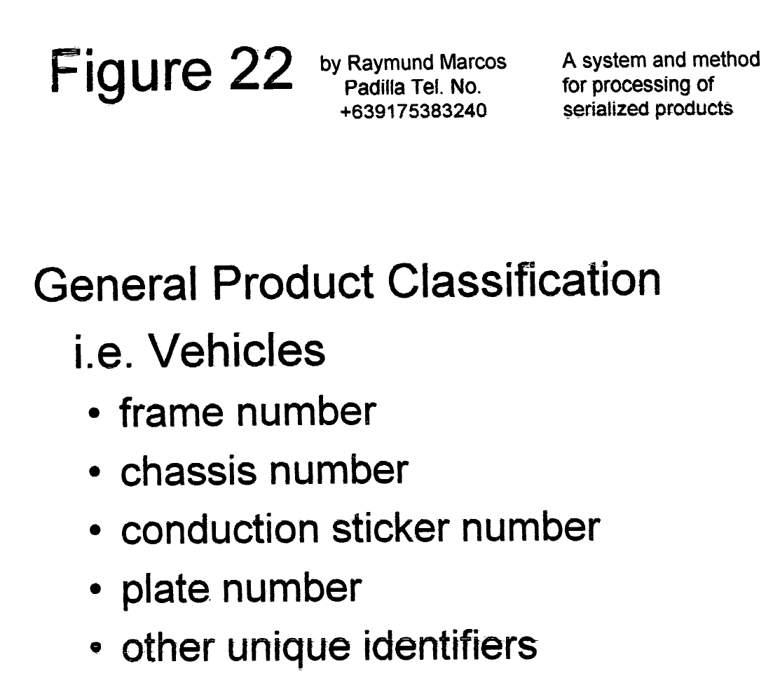

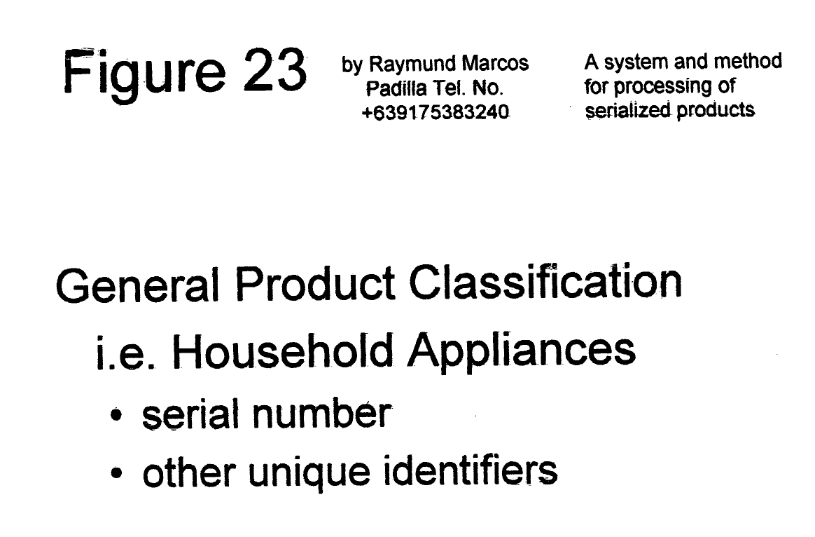

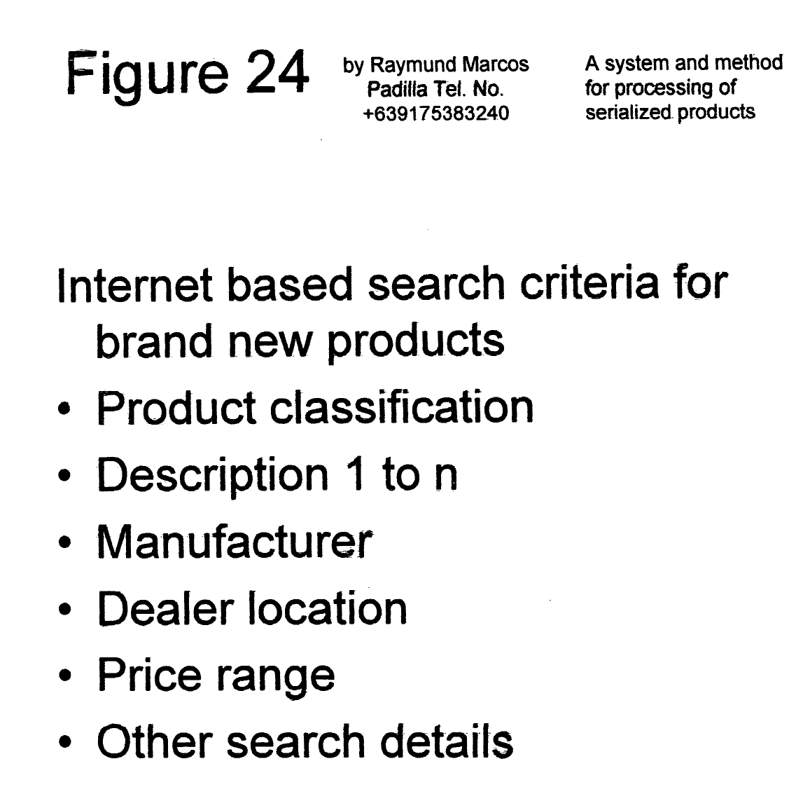

These are the processes:
1. PROCESS 1—MASTER DATA UPLOAD: The process starts when the Manufacturer sends the manufacturer master data (FIG. 4), dealer master data (FIG. 5) and product master data (FIG. 6) into the invention via the internet. The process ends when these data are stored in the database servers of the invention as provided in FIG. 3.
   Every time that the manufacturer creates and sends the sales order to the invention system, the sales order information as provided in FIG. 14 is transmitted to th invention's database system via internet using internet based standards and technologies.
   All products in the sales order will have a unique identifying number (UIN) that will be extracted, transmitted and stored in the invention's database system.
   FIG. 7 provides an understanding that each product code maintains a multiple unique identification numbers (UINs) that will be transmitted, extracted and stored in the invention's database system.
   FIG. 8 provides an understanding that each product code is capable of maintaining a set of multiple unique identification numbers that will be transmitted, extracted and stored in the invention's database system.
   FIG. 9 provides an example of a product code with a set of multiple unique identification numbers. The example is a vehicle code with a set of descriptions mentioning that it is a sedan with an automatic transmission of model x. This vehicle code maintains a set of unique identification numbers such as frame number, engine number and etc.
   FIG. 10 provides an example of a product code which is a vehicle code wherein each vehicle code maintains multiple vehicles with unique identifying numbers. This mentions that a product code can have the same product codes for same products but with different set of unique identification numbers.
   FIG. 11 provides another example of a product code with a set of multiple unique identification numbers. The example is a PDA code with a set of descriptions mentioning that it is an O2 brand of portable device that is a pocket pc and a phone. This PDA code maintains a set of unique identification numbers such as SN, IMEI Number and other unique identifiers.
   FIG. 12 provides another example of a product code with a set of multiple unique identification numbers. The example is a household appliance code with a set of descriptions mentioning that it is a model z refrigerator with a 6 cubic feet dimension. This household appliance code maintains only one UIN.
   Most of these data are available in the manufacturer's business applications in different naming conventions or made available thru work around procedures. The invention extracts and standardizes these data with the proper authorization from th manufacturer's business application via the invention's software development kits (SDKs), transmits and stores into the invention's database system.
   Sales orders being transmitted by manufacturers are purely dealer orders and not first buy customer orders. These sales orders carry the unique identifying numbers (UIN) attached to each product code. Confirmed sales orders are transmitted, filtered and stored to the invention's system as provided in FIG. 13 with the data in FIG. 17 being stored in the invention system. FIG. 15 provides an understanding that inventory data is passed on by the dealer's current business application system after filtering the inventory required for the invention's internet based selling engine.
   All manufacturers' sales orders transmitted via the invention system are also transmitted to the dealer's business application for inventory and financial records updating. Dealers without any current business application can have the option to use the invention's hosted purchasing, inventory and financial system as provided in FIG. 16. All customer records will be created in the invention's customer portal. These customer records are being entered into the invention whenever a 1) customer wanted to access the invention's search engine for a preferred product or 2) a dealer closes a deal with a customer in the dealer location.
2. PROCESS 2—USER AND COMPANY REGISTRATION: This process starts and ends when manufacturers and dealers register their company and named users into the invention. A dealer accreditation process is also included.
Manufacturers register using the manufacturer portal found in FIG. 18. Manufacturers have the option to manually encode or automatically transmit their data as found in FIG. 4. Afterwards, the invention confirms the successful registration by providing a user name and password for secured access into the invention. The manufacturer is now ready to upload their manufacturer master data (FIG. 4), dealer master data (FIG. 5) and product master data (FIG. 6).
   After the manufacturer sends a list of certified dealers into the invention during the initial data upload, dealers on the other hand can already start creating user authorizations for their representatives. The invention provides a dealer portal as provided in FIG. 18. Afterwards, the invention confirms the successful registration by providing a user name and password for secured access into the invention.
   There are three kinds of dealer user profile in the invention namely 1) sales manager profile 2) service manager profile and 3) approver profile. The sales manager profile has an access to the customer master records and sales processing portion of the invention. The service manager profile has an access to customer code with corresponding product master record and service processing portion of the invention. The approver profile has an access to any documentation or process that needs their approval. The invention will also provide relevant reports for these profiles.
   Dealers initially not certified by the manufacturer will not have any dealer code in the invention's system. Therefore, they need to create one. A dealer representative creates a dealer master record by filling up all fields found in FIG. 5 provided in the dealer portal. In addition to these fields, they are also provided with a screen where they can tag all the manufacturers that supply the products that they carry and a dealer accreditation screen where data are inputted for th manufacturer to review prior to certification. This information is passed to the manufacturer and accessed via the manufacturer portal found in the invention's system.
   The primary limitation of a dealer not certified by the manufacturer is that they are not authorized to service the serialized products being bought by the customer from other authorized dealers. But this does not stop the customer or the dealer to process the service requirements of the customer via the invention system while the certification is ongoing. The invention system will allow service processing by the non-certified dealer except that the invention will not include the service history in the appraised value computation and viewing by potential buyers. This information will be stored and tagged as pending in the invention's system and will be released for inclusion in the appraised value computation and viewing by potential buyers only upon granting of dealer certification by the manufacturer.
   The invention allows each manufacturer to have multiple certified dealers and dealers with multiple manufacturers. The invention allows multiple user registration for each manufacturer and dealer.
3. PROCESS 3—CUSTOMER INQUIRY AND REGISTRATION: This process starts when interested buyers/prospects check brand new and available serialized products by connecting to the invention system using the internet at any given time at any given place. The prospect, the first timer, is allowed to search and view all brand new products based on the prospects preference. Afterwards, the prospect will be subjected for customer registration so that a password is provided to the prospect for them to proceed with the inquiry. This process ends when the prospect is already confirming his inquiry on the preferred serialized product to buy. This process is available in the invention's customer portal.
   The internet search engine of the invention's customer portal provides check boxes with information about the product classification, product descriptions, manufacturer name, dealer location, price range etc. with a submit button after the preferences are selected by the prospect as provided in FIG. 24. A list of product classification is provided in FIG. 21. A sample of the general product classification is found on FIG. 22 and FIG. 23 whore the invention will prompt for a unique set of UIN for each product classification.

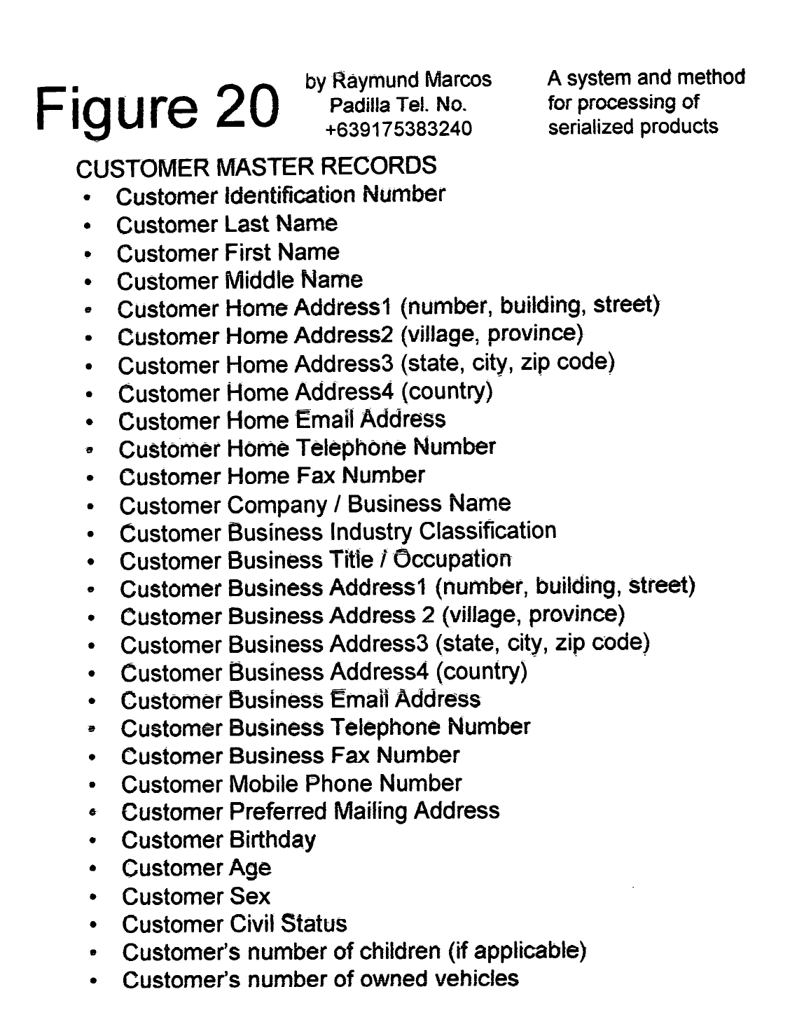

The invention system will search all available units based on the prospect's search criteria as provided in FIG. 24 and the result is displayed. The system will prompt for a message if the prospect intends to proceed. Afterwards, the system will prompt for the customer registration screen with the following fields provided in FIG. 20.

After completing the customer registration, the system will send a password to the prospect thus allowing further access into the system. The process ends when the prospect confirms the order and enters mode of payment details. The invention will use different modes of payment such credit card, bank to bank transfers, cash upon delivery, paypal, payplus or any mode of payment that is currently available in the internet.

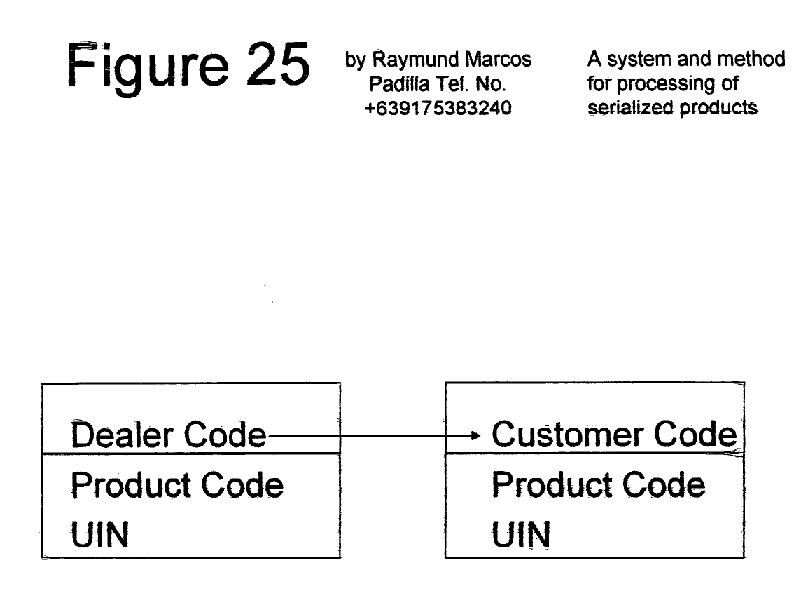

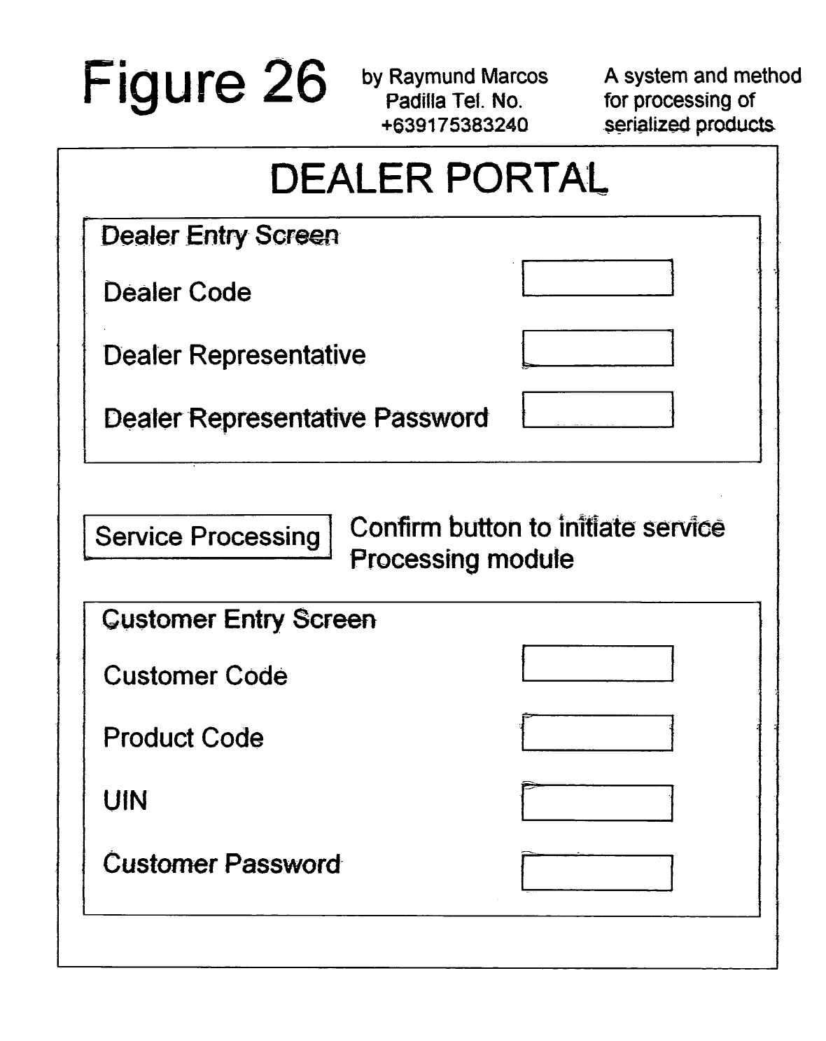

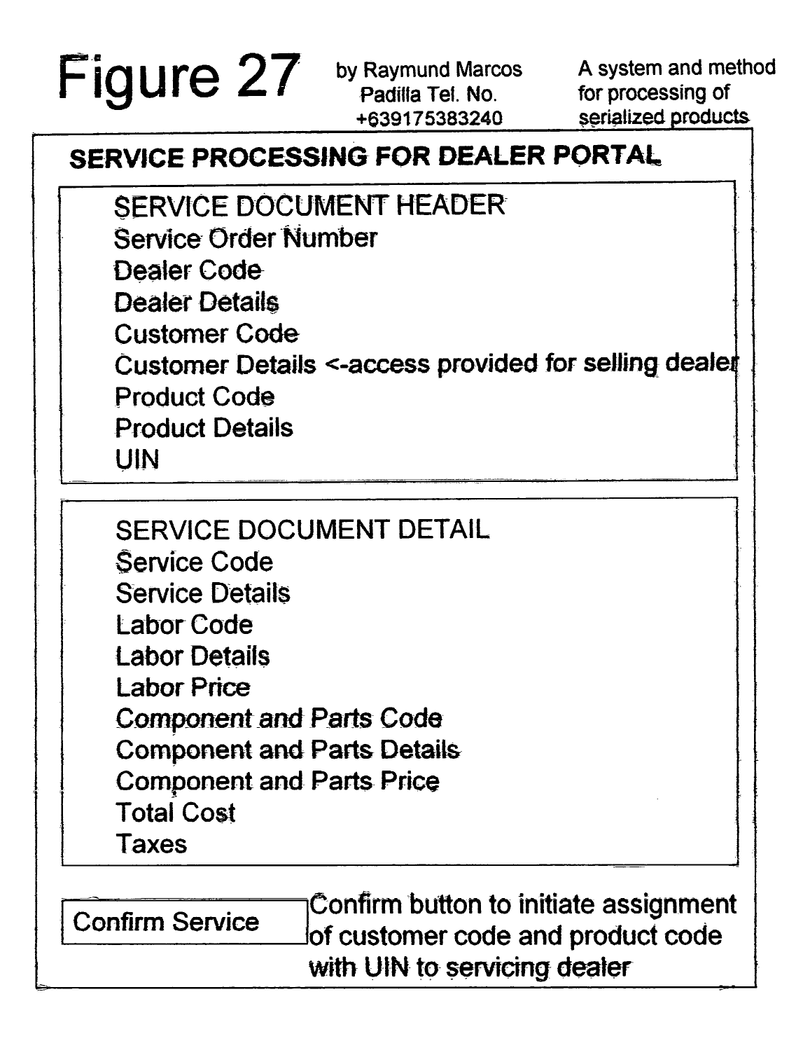

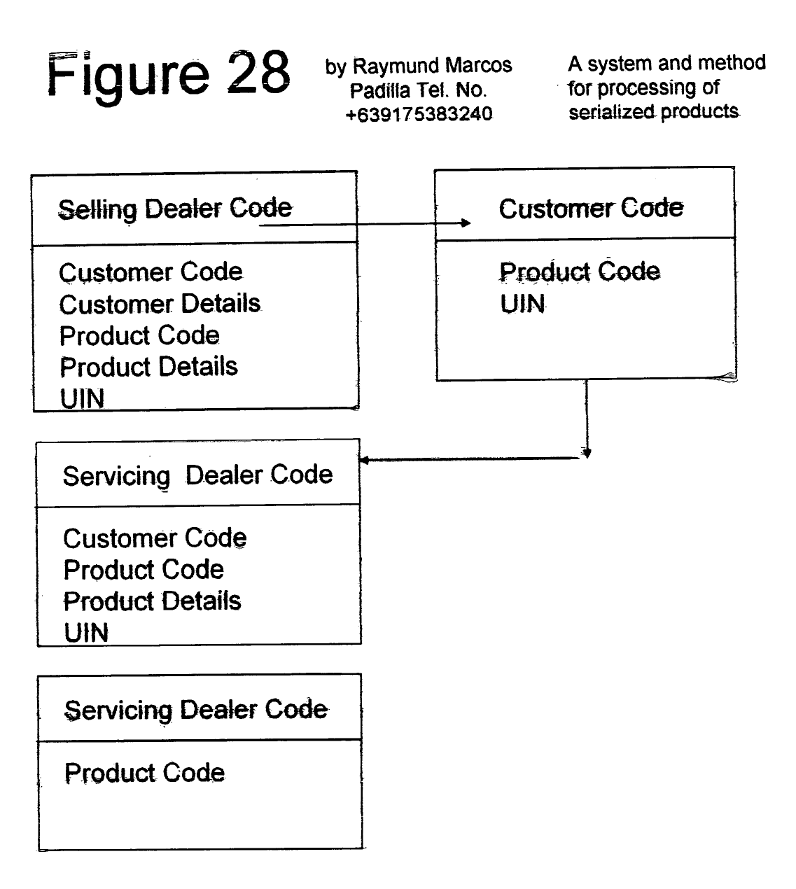

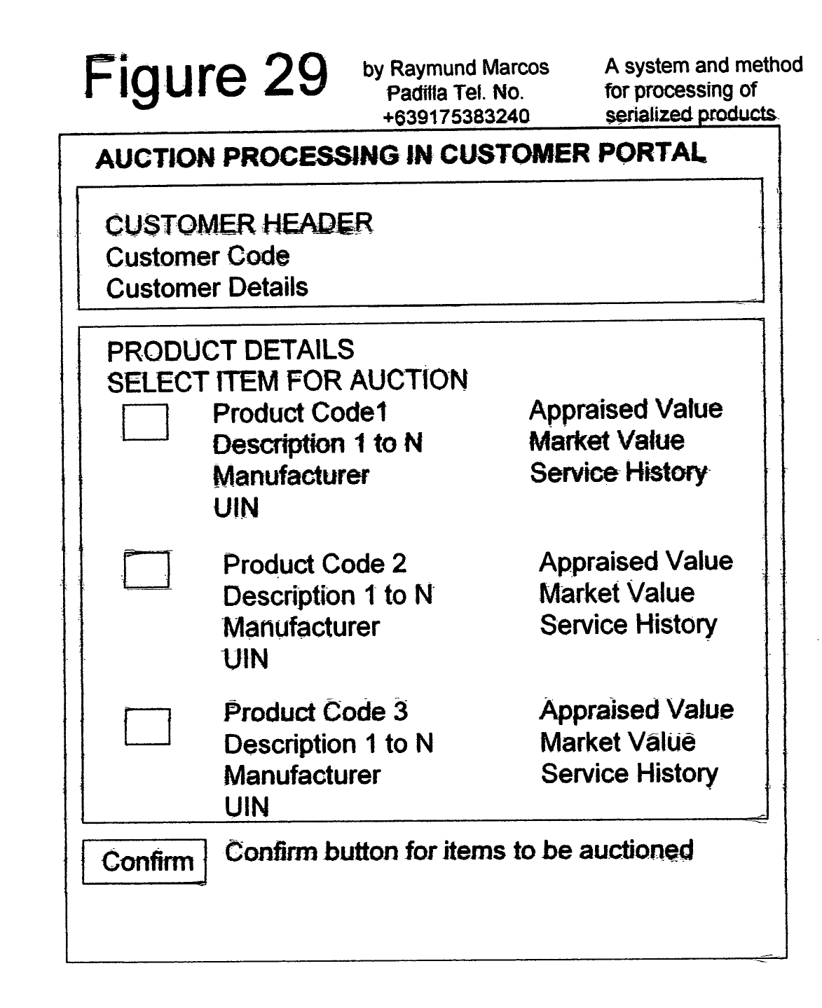

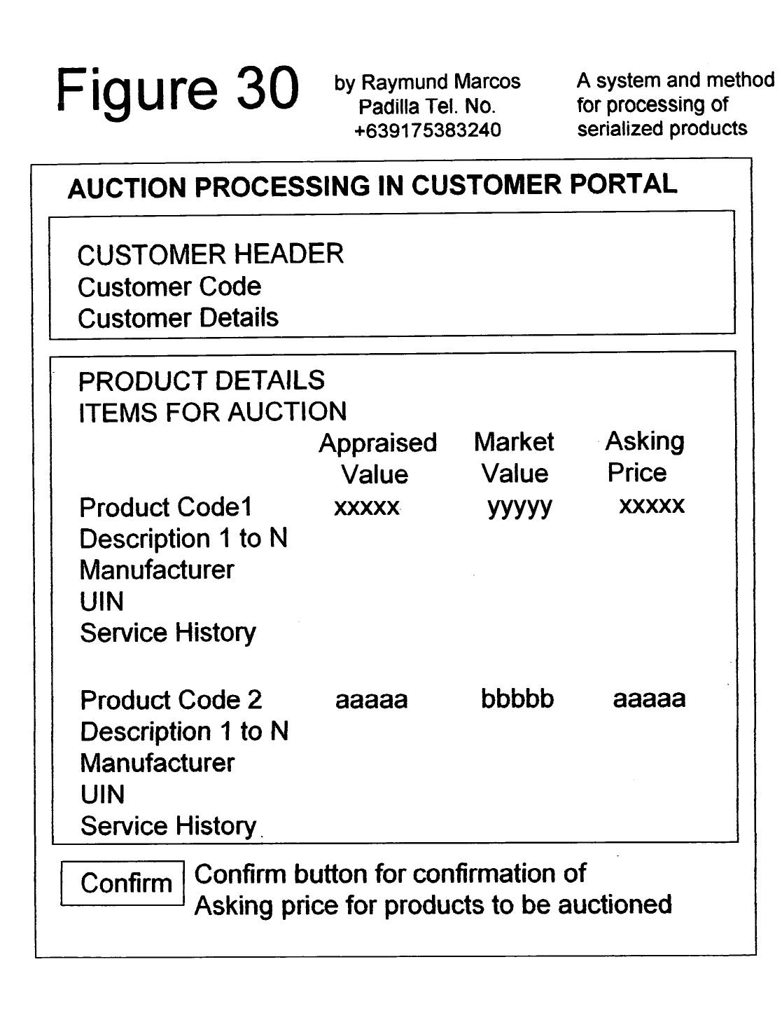

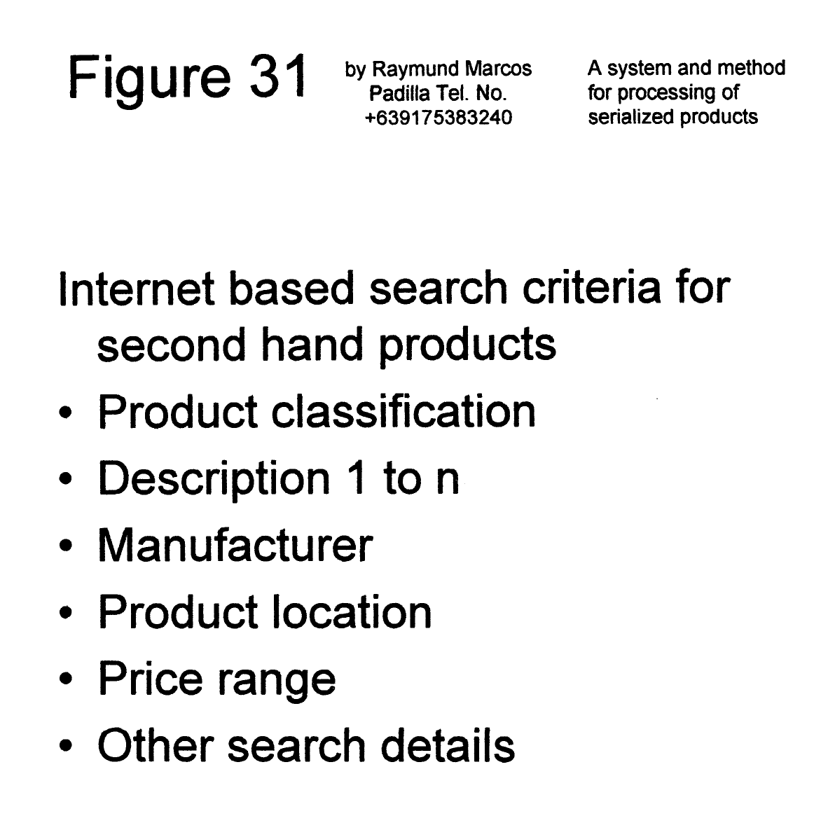

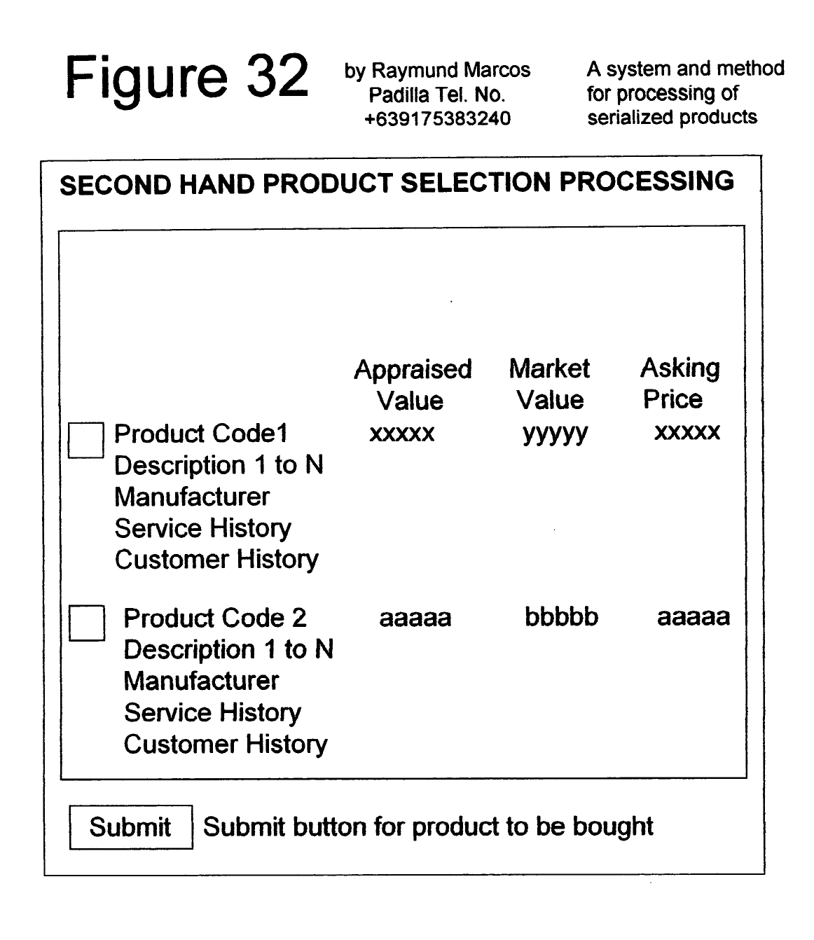

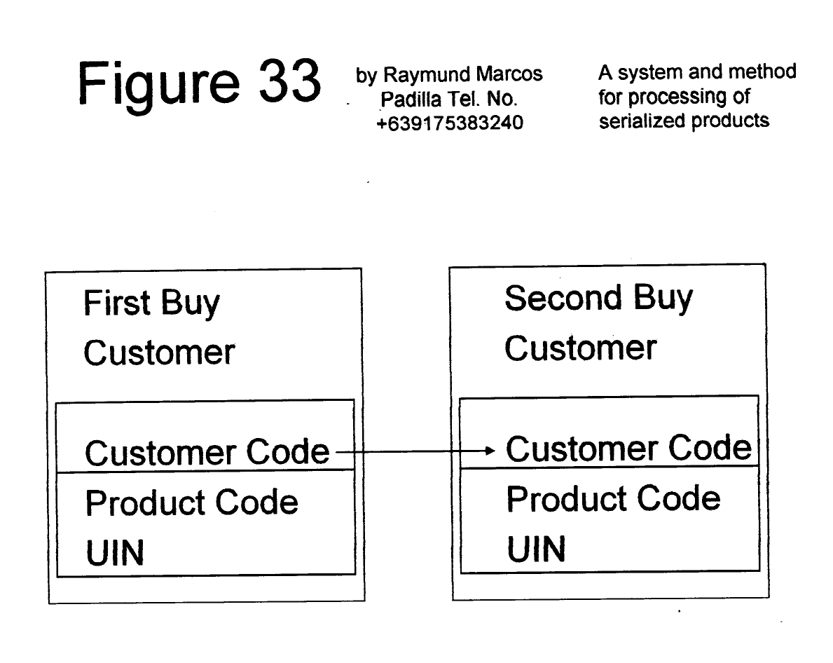

The customer information and customer sales inquiry are both stored in the invention database system and/or forwarded to the dealer's current business application.
4. PROCESS 4—SALES AND SHIPMENT PROCESSING: This process starts when the dealer retrieves the customer inquiry and ends when the dealer confirms this inquiry into a sales order and provides a shipment notification to the customer. Of course, this will be processed with the concurrence of the prospect after finalizing the negotiation.
   Dealers and potential buyers has the option of using messaging or chat room systems found on the invention system for continuous discussion to confirm the sale for brand new serialized products. After agreement between dealer and buyer has been finalized, a shipping notification is sent to the buyer to validate that the sale has been pressed the selling entity.
   Only the prose identified dealer can access the inquiries made by the prospect and convert these into sales orders. Afterwards, a shipping notification is sent to the customer.
5. PROCESS 5—RECLASSIFICATION FROM DEALER STOCK INTO CUSTOMER OWNED SERIALIZED PRODUCT. Once the dealer triggers a sales order and a shipping notification in the invention system, the invention sys the dealer owned serialized product into customer owned product as provided in FIG. 25. This customer owned product is now classified as a serviceable product in th invention system.
   For the dealer with a business application, serialized product inventory is automatically deducted from the business application system. There will be a bidirectional flow of information that allows that consistent update of inventory quantity both at the invention system and at the dealer's business application.
   For the dealer without a business application, the invention system will provide a hosted business application for sales, inventory and service processing.
   The invention system's dealer portal will allow the retrieval of the complete customer records for the dealer where the customer purchased the products. These records are restricted to the selling dealer and are not being shared to the other servicing dealers. Servicing dealer access is restricted to the customer code, product information and previous service history. This access is triggered with the concurrence of the customer who wanted to service the product
6. PROCESS 6—SERVICE AND WARRANTY PROCESSING: The process starts when the customer's product undergoes a service and warranty processing and ends upon service completion and payment.
   Customer visits a dealer for servicing. If the dealer is servicing the customer for the fast time, customer enters selected fields in the dealer portal of the invention system to allow and establish a link between dealer and customer data and product data. The logical entry screen is provided in FIG. 26. Only the selling dealer will have access to the full customer master data while other servicing dealers' access is restricted to the customer code, product information and previous service history as provided in FIG. 28. This process happens in the dealer portal of the invention system.
   After the establishment of the servicing dealer, customer code and product records link has been made, the dealer portal will now provide access to the service processing portion of the dealer portal of the invention system.
   The service processing portion of the invention system will provide a screen that the dealer can use to search for the preventive maintenance and defect codes. These codes will provide a series of service activities with corresponding corrective actions, labor and parts requirement and the estimated costs of servicing.
   A servicing dealer access the service processing module of the invention system. This module replicates and uploads all information on preventive maintenance and defect codes, service activities, labor and parts codes, and corresponding costs of the dealer's business application. The service processing module provides a logical screen reflecting the service document header and service document details as displayed in FIG. 27.
   The service processing portion of the invention system will process the following: 1) update of serialized counter readings if required (i.e. odometer reading for vehicles, number of hours usage for generators, number of units produced for production equipments, and etc.), 2) service request preparation, 3) service request conversion into service order, 4) parts and labor reservation and allocation, 5) service costs calculation, 6) service code database storage and retrieval, 7) financial transactions creation and update, 8) billing and receivables creation and 9) customer payment processing.
   Warranty claims can be processed further between the dealer and manufacturer using their business application management module.
   Afterwards, the following information is transmitted to and stored into the invention system to record service history:
      1. Customer Code
      2. Product Code
      3. UIN
      4. Dealer Code
      5. Service Order Number
      6. Service Code
      7. Service Description
      8. Service Costs
      9. Service Date
   For dealers without a business application, the invention system provides a hosted business application for service processing. The primary intent of this program is to enter and store vital service details for service history retrieval, billing creation and printing.
   The service process ends when customer pays for the service rendered.
   Also the invention system will use the service history to provide service notifications to customers in the future via mail or fax while at the same time provide an automatic reservation of time slot for servicing of the serialized product to the nearest service center. The invention system will use a formula to compute for forecasted and estimated counter reading and provide the corresponding service description to the customer.
7. PROCESS 7—AUCTION: The process starts when the first buy customer registers the product for auction. Process ends when the second buy customer sends payment to the seller.
   For customers who wanted to sell their serialized products via internet, the auction services of the invention system will allow them to easily convert their owned product into a product for auction.
   A system prompt confirms if the customer intends to convert owned serialized product for auctioning as provided in FIG. 29. Upon confirmation, the serialized product for auction is listed in the auction page.
   The following information is extracted by the auction system of the invention:
      1. Customer ID
      2. Customer Name
      3. Customer Contact Details
      4. Product Code
      5. Product Classification
      6. Product Description/s
      7. Product Service History
         7.1. Service Code
         7.2. Service Description
         7.3. Service Date
      8. Product acquisition date
   Also, the auction services of the invention system will provide an appraised value model to calculate the estimated value of the second hand serialized product based on an applicable depreciation model with appreciation cost calculation based on repair history. In the auction services of the invention system, it will provide an appraised value, the seller's initial asking price and the market value of the same product. An entry field is provided for the seller's asking price of which the default figure is the appraised value as provided in FIG. 30.
   The second hand product is now ready for auction. Any prospects or existing customers interested in buying the second hand product can view it in the public page of the invention system.
   The internet search engine of the invention's customer portal provides the information found on FIG. 31. The invention system will search all available units based on the prospect's preference and the result is displayed. The prospect selects and submits as provided in FIG. 32.
   The system prompts for the customer registration screen with the following fields provided in FIG. 18 if the customer is not yet registered. After registration, the prospect is allowed to access service histories and contact details of the seller.
   The invention system will list all second hand products in conformance to the search criteria. Interested buyers can click a link for payment processing based on various modes of payment
   Seller and buyer has the option of using messaging or chat room systems found on the invention system for continuous discussion to confirm the sale of second hand serialized products. After th agreement between seller and buyer has been finalized, a shipping notification is sent to the buyer.
   The buying entity will confirm the shipping notification once the buying entity receives the product being bought. This confirmation is made in the invention system. Upon confirmation, the invention system will automatically convert the recently bought second hand serialized product's customer code assignment (seller) into the new customer code (second hand buyer) as provided in FIG. 33. The serialized product ownership record will be updated and stored in the invention system.
   Service history and ownership history are stored for future retrieval by interested buyers and servicing dealers.
   If the customer does not have or own any personal computer or any devices with access to the internet, the customer can use smart cards, mobile devices, usb devices and other related devices for redundant storage of customer, serialized product and dealer data to be used for data synchronization with the invention's internet based portal. There is an option for the user to download and use a mobile version of the invention.
   In the event that product diagnostics systems are incorporated in the serialized product and made internet ready, the invention will extract the data from this diagnostic systems, store and use this data for service and repair related activities.
   This invention will also provide a standard format for manufacturers and dealers to use for synchronization and automation of service manuals which include part code and description, fault/defect code and descriptions, service code and description, labor code and description and other related data. These data are downloadable to mobile devices used for service related activities.
   While this invention has been shown, illustrated and decribed based on the detailed discussion and accompanying figures and drawings thereof, it will be understood by those skilled in the art that other modifications may be made therein without departing from the spirit and scope of this invention.

1. A system and method for an internet based collaborative business to business and business to consumer ordering, selling, servicing, warranty processing, remarketing, billing, payment, auction, shipment and monitoring of serialized products anywhere and anytime among various manufacturers, dealers and customers.

2. A system according to claim 1 that covers an infrastructure that includes computer hardware, computer software, programs, databases, development tools, internet applications, enterprise resource planning systems, legacy systems, point systems, business applications, internet systems, browsers, enterprise application interfaces, protocols, connectors, networks, wireless and mobile technology to process the transactions related to the proposed system and method.

3. A system according to claim 1 that allows the master data upload of manufacturer master data (FIG. 4), dealer master data (FIG. 5) and product master data (FIG. 6).

4. A system according to claim 1 that allows the manufacturer to send the sales order information as provided in FIG. 14 into the invention's database system via internet using internet based standards and technologies.

5. A system according to claim 1 that allows the serialized product's unique identifying number (UIN) to be extracted, transmitted and stored in the invention's database system.

6. A system according to claim 1 that allows manufacturers' sales orders transmitted via the invention system to be transmitted to the dealer's business application for inventory and financial records updating.

7. A system according to claim 1 that allows dealers without any current business application to use the invention's hosted purchasing, inventory and financial system as provided in FIG. 16.

8. A system according to claim 1 that allows the registration of manufacturer's company and named users into the invention's manufacturer portal.

9. A system according to claim 1 that allows the registration of dealer's company and named users into the invention's dealer portal.

10. A system according to claim 1 that allows dealer accreditation processing.

11. A system according to claim 1 that provides user name and password for secured access by all participants.

12. A system according to claim 1 that allows maintenance of three kinds of dealer user profile in the invention namely 1) sales manager profile 2) service manager profile and 3) approver profile. The sales manager profile has an access to the customer master records and sales processing portion of the invention. The service manager profile has an access to customer code with corresponding product master record and service processing portion of the invention. The approver profile has an access to any documentation or process that needs their approval. The invention will also provide relevant reports for these profiles.

13. A system according to claim 1 that allows service processing of dealers with pending accreditation.

14. A system according to claim 1 that disallows the invention from including the service history in the appraised value computation and viewing by potential buyers. This information will be stored and tagged as pending in the invention's system and will be released for inclusion in the appraised value computation and viewing by potential buyers only upon granting of dealer accreditation by the manufacturer.

15. A system according to claim 1 that allows each manufacturer to have multiple certified dealers and dealers with multiple manufacturers in the invention's database system.

16. A system according to claim 1 that allows multiple user registration for each manufacturer and dealer.

17. A system according to claim 1 that allows search and view of all registered new serialized products based on the prospect's preference.

18. A system according to claim 1 that allows for customer registration so that a password is provided to the prospect for them to proceed with the inquiry.

19. A system according to claim 1 that allows product search using check boxes with information about the product classification, product descriptions, manufacturer name, dealer location, price range etc. with a submit button after the preferences are selected by the prospect as provided in FIG. 24.

20. A system according to claim 1 that allows listing of product classification as provided in FIG. 21. A sample of the general product classification is found on FIG. 22 and FIG. 23 where the invention will prompt for a unique set of UIN for each product classification.

21. A system according to claim 1 that allows different modes of payment such as credit card, bank to bank transfers, cash upon delivery, paypal, payplus or any mode of payment based on customer preference.

22. A system according to claim 1 that allows storage of customer information and sales inquiry in the invention database system.

23. A system according to claim 1 that allows dealer retrieval of customer inquiry in the invention's dealer portal.

24. A system according to claim 1 that allows dealer confirmation of customer sales inquiry into a sales order and provides a shipment notification to the customer.

25. A system according to claim 1 that limits access to prospect's identified dealer for the sales inquiry processing.

26. A system according to claim 1 that allows reclassification of customer bought serialized product from dealer classified stock into customer owned serialized product. This customer owned product is now classified as a serviceable product in the invention system.

27. A system according to claim 1 that allows inventory reduction in the dealer's current business application that is connected to the invention once the sales order has been confirmed.

28. A system according to claim 1 that allows hosting of various business applications for sales, inventory, purchasing, financial and service processing by the invention.

29. A system according to claim 1 that allows retrieval of the complete customer records for th dealer where the customer purchased the products.

30. A system according to claim 1 that allows restricted retrieval of information by servicing dealers (not the original selling dealer of the product to be serviced). Servicing dealer access is restricted to the customer code, product information and previous service history. This access is triggered with the concurrence of the customer who wanted to service the product.

31. A system according to claim 1 that allows selected field entries by customers who intend to service their owned serialized products for th first time to the identified service dealer (not the selling dealer) thus establishing a link between servicing dealer and customer data and product data. The logical entry screen is provided in FIG. 26. Only the selling dealer will have access to the full customer master data while other servicing dealers' access is restricted to the customer code, product information and previous service history as provided in FIG. 28. This process happens in the dealer portal of the invention system.

32. A system according to claim 31 that provides access to the service processing portion of the dealer portal of the invention system.

33. A system according to claim 1 that allows searching of preventive maintenance and defect codes in the service processing portion of the dealer portal of the invention system. These codes will provide a series of service activities with corresponding corrective actions, labor and parts requirement and the estimated costs of servicing.

34. A system according to claim 1 that allows replication and upload of all information on preventive maintenance and defect codes, service activities, labor and parts codes, and corresponding costs found on dealer's current business application. The service processing module provides a logical screen reflecting the service document header and service document details as displayed in FIG. 27.

35. A system according to claim 1 that allows processing of the following in the service processing module of the invention: 1) update of serialized counter readings if required (i.e. odometer reading for vehicles, number of hours usage for generators, number of units produced for production equipments, and etc.), 2) service request preparation, 3) service request conversion into service order, 4) parts and labor reservation and allocation, 5) service costs calculation, 6) service code database storage and retrieval, 7) financial transactions creation and update, 8) billing and receivables creation and 9) customer payment processing.

36. A system according to claim 1 that allows database storage of the following information to record service history: 1) Customer Code, 2) Product Code, 3) UIN, 4) Dealer Code, 5) Service Order Number, 6) Service Code, 7) Service Description, 8) Service Costs, and 9) Service Date.

37. A system according to claim 1 that allows retrieval of service history to provide service notifications to customers in the future via email, fax or customer portal in the invention system while at the same time provide an automatic reservation of time slot for servicing of the serialized product to the nearest service center.

38. A system according to claim 1 that provides a computation for the forecasted and estimated counter reading to be used to project preventive maintenance schedules and provide the corresponding service description to the customer in the service notifications.

39. A system according to claim 1 that allows automatic conversion of products for auction by seller thru a button with a function that automatically converts the products as auction items.

40. A system according to claim 1 and claim 39 that allows extraction of the following information to be processed by the auction system of the invention: 1) Customer ID, 2) Customer Name, 3) Customer Contact Details, 4) Product Code, 5) Product Classification, 6) Product Description/s, 7) Product Service History, and 8) Product Acquisition Date.

41. A system according to claim 1 that allows calculation of the appraised value based on depreciation, service repair histories and other factors affecting the appraised value.

42. A system according to claim 1 that allows input and display of seller's initial asking price in the invention's auction services.

43. A system according to claim 1 that allows searching of preferred second hand serialized products and viewing by prospects or existing customers interested in buying the second hand product in the public page of the invention system.

44. A system according to claim 1 that allows customer registration for new prospects interested in buying second hand serialized products. After registration, the prospect is allowed to access service histories and contact details of the seller.

45. A system according to claim 1 that allows listing of all second hand products in conformance to the search criteria defined by the interested buyers. Interested buyers can click a link for payment processing based on various modes of payment.

46. A system according to claim 1 that allows an option of using messaging or chat room systems found on the invention system for continuous discussion to confirm the sale of second hand serialized products. After the agreement between seller and buyer has been finalized, a shipping notification is sent to the buyer.

47. A system according to claim 1 that allows reclassification of customer bought second hand or used serialized product from sell r's customer code into the new customer code (second hand buyer) as provided in FIG. 33. The serialized product ownership record will be updated and stored in the invention system.

48. A system according to claim 1 that allows usage of smart cards, mobile devices, usb devices and other related devices for redundant storage of customer, serialized product and dealer data to be used for data synchronization with the invention's internet based portal. There is an option for the user to download and use a mobile version of the invention.

49. A system according to claim 1 that allows extraction of data by the invention from product diagnostic systems, store and use this data for service and repair related activities.

50. A system according to claim 1 that provides a standard format for manufacturers and dealers to use for synchronization and automation of service manuals which include parts code and description, fault/defect code and descriptions, service code and description, labor code and description and other related data. These data are downloadable to mobile devices used for service related activities.
